(19) United States
(12) Patent Application Publication
(10) Pub. No.: US 2014/0337120 A1
(43) Pub. Date: Nov. 13, 2014

(54) INTEGRATING MEDIA ANALYTICS TO CONFIGURE AN ADVERTISING ENGINE

(71) Applicant: Radiate Media Holding Company, Salt Lake City, UT (US)

(72) Inventor: Corey Ercanbrack, Salt Lake City, UT (US)

(21) Appl. No.: 14/272,312

(22) Filed: May 7, 2014

Related U.S. Application Data
(60) Provisional application No. 61/821,144, filed on May 8, 2013.

(51) Int. Cl. G06Q 30/02

(52) U.S. Cl. CPC G06Q 30/0244
USPC 705/14.43

(57) ABSTRACT

An apparatus, system, and method are disclosed for integrating media analytics to configure an advertising engine. In one embodiment, a method includes advertising based on an advertising campaign, the advertising campaign comprising a plurality of advertising entities, the advertising campaign based on a set of configuration parameters, monitoring results of one or more of the advertising entities, and modifying one or more of the configuration parameters based on the results.

### CROSS-REFERENCES TO RELATED APPLICATIONS

This application claims the benefit of U.S. Provisional Patent Application No. 61/821,144 entitled “INTEGRATING MULTIPLE MEDIA ANALYTICS TO CONFIGURE AN ADVERTISING ENGINE” and filed on May 8, 2013 for Corey Ercanbrack, which is incorporated herein by reference.

### FIELD

This invention relates to advertising and more particularly relates to integrating media analytics to configure an advertising engine.

### BACKGROUND

Advertising in the current technological landscape may be difficult for many users. There are many different advertising entities that offer a wide variety of advertising technologies. In order to advertise effectively, a user may require advance knowledge of the different advertising mechanisms available. If may be overwhelming for a user to develop sufficient knowledge of the myriad of different advertising technologies.

Furthermore, advertising effectively may be difficult without advertising experience in certain arenas. Certain advertisements may be more effective in certain areas, demographics, countries, societies, etc. and developing expertise in these various advertising fields may be difficult.

### SUMMARY

An apparatus for integrating media analytics to configure an advertising engine is disclosed. A method and computer program product also perform the functions of the apparatus. In one embodiment, the apparatus includes a campaign manager module that advertises based on an advertising campaign. The advertising campaign may include many advertising entities and the advertising campaign may be based on a set of configuration parameters. In one embodiment, the apparatus includes a results module that monitors results of one or more of the advertising entities. The campaign manager module may update one or more of the configuration parameters based on the results. In another embodiment, at least a portion of the campaign manager module and the results module comprise one or more of hardware and executable code, the executable code stored on one or more computer readable storage media.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system in accordance with the present disclosure;

FIG. 2 is another schematic block diagram illustrating one embodiment of a system in accordance with the present disclosure;

FIG. 3 is a schematic block diagram illustrating one embodiment of a campaign manager module;

FIG. 4 is another schematic block diagram illustrating one embodiment of a campaign manager module;

FIG. 5 is a schematic block diagram illustrating one embodiment of a system in accordance with the present disclosure;

FIG. 6 is a schematic block diagram illustrating one embodiment of a system in accordance with the present disclosure;

FIG. 7 is a flow chart diagram illustrating one embodiment of a method in accordance with the present disclosure;

FIG. 8 is a flow chart diagram illustrating another embodiment of a method in accordance with the present disclosure;

FIG. 9 is an illustration depicting one embodiment of a user interface in accordance with the present disclosure;

FIG. 10 is an illustration depicting one embodiment of a user interface in accordance with the present disclosure;

FIG. 11 is an illustration depicting one embodiment of a user interface in accordance with the present disclosure;

FIG. 12 is an illustration depicting one embodiment of a user interface in accordance with the present disclosure;

FIG. 13 is an illustration depicting one embodiment of a user interface in accordance with the present disclosure;

FIG. 14 is an illustration depicting one embodiment of a user interface in accordance with the present disclosure;

FIG. 15 is an illustration depicting one embodiment of a user interface in accordance with the present disclosure;

FIG. 16 is an illustration depicting one embodiment of a user interface in accordance with the present disclosure;

FIG. 17 is an illustration depicting one embodiment of a user interface in accordance with the present disclosure; and

FIG. 18 is a flow chart diagram illustrating another embodiment of a method in accordance with the present disclosure.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer readable medium may be a tangible computer readable storage medium storing the program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store program code for use by and/or in connection with an instruction execution system, apparatus, or device.

The computer readable medium may also be a computer readable signal medium. A computer readable signal medium may include a propagated data signal with program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport program code for use by or in connection with an instruction execution system, apparatus, or device. Program code embodied on a computer readable signal medium may be transmitted using any appropriate medium, including but not limited to wire-line, optical fiber, Radio Frequency (RF), or the like, or any suitable combination of the foregoing

In one embodiment, the computer readable medium may comprise a combination of one or more computer readable storage mediums and one or more computer readable signal mediums. For example, program code may be both propagated as an electro-magnetic signal through a fiber optic cable for execution by a processor and stored on RAM storage device for execution by the processor.

Program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program product may be shared, simultaneously serving multiple customers in a flexible, automated fashion. The computer program product may be standardized, requiring little customization and scalable, providing capacity on demand in a pay-as-you-go model. The computer program product may be stored on a shared file system accessible from one or more servers.

The computer program product may be integrated into a client, server and network environment by providing for the computer program product to coexist with applications, operating systems and network operating systems software and then installing the computer program product on the clients and servers in the environment where the computer program product will function.

In one embodiment software is identified on the clients and servers including the network operating system where the computer program product will be deployed that are required by the computer program product or that work in conjunction with the computer program product. This includes the network operating system that is software that enhances a basic operating system by adding networking features.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by program code. The program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As disclosed herein, various media entities may be managed by a campaign manager module 150. In one embodiment, a media entity may include television broadcast media. Television broadcast media may be short form or long form. In another embodiment, the broadcast signal may include an analog or a digital signal. The broadcast signal may be interlaced, and may include hidden signals for encoding metadata. Hidden signals may include tele-text, closed captioning, or to indicate a format of the broadcast signal. In another embodiment, the television broadcast signal may be modulated. In one embodiment, the television broadcast signal may include many different standards, lines, frame rates, bandwidths, sound carrier separation frequency, sideband frequency, vision modulation, sound modulation, chrominance subcarrier frequency, vision/sound power ratio, usual color, or the like.

In another embodiment, a media entity may include a radio broadcast signal. A radio broadcast signal may be from 30 kHz or lower, to 300 GHz or higher. A radio broadcast signal may be modulated, may be transmitted via a radio antenna, may use frequency-division multiplexing (FDM), may use frequency modulation (FM), may use amplitude modulation (AM), may include a subcarrier, may include single sideband voice, may include an analog signal, may include a digital signal, may include frequency-shift-keying. In one embodiment, the radio broadcast transmitter may be licensed or unlicensed.

In another embodiment, a media entity may include a newspaper A newspaper may include a periodical, news, current events, information, articles, other features, editorials, advertising, or the like. In another embodiment, a newspaper may include editorial opinions, criticism, persuasion, op-eds, obituaries, entertainment features, games, crosswords, Sudoku, horoscopes, weather, advice, food, review of other media entities, reviews of movies, plays, restaurants, classified ads, display ads, radio and television listings, merchant inserts, editorial cartoons, gag cartoons, comic strips, or the like.

In another embodiment, a media entity may include a business listing directory. A business listing directory may be printed or Internet based. A business listing or directory service may be categorized or organized in a variety of different ways, including, but not limited to, alphabetically, geographically, or the like.

In another embodiment, an internet business listing may be one of Google, Bing, Yahoo!, Yelp, Merchant Circle, LinkedIn, YellowPages.com, Whitepages, Supermedia, Yellowbook, CitySearch, Mapquest, Biznik, Local.com, Foursquare, ThinkLocal, CitySlick, USYellowPages, SuperPages, Outside.in, Dex, BizJournals.com, TeleAtlas, JustClickLocal, Discover our Town, Metrobot, MerchantCircle, EZ Local, twibs, LocalEze, Kudzu, CityVoter, Manta, Zipweb, MatchPoint, UsCity.net, Local Site Submit, InfoUSA, Axciom, Infignos, Yellow Assistance, Get Fave, My Huckleberry, GenieKnows, MojoPages, Brownbook, Magic Yellow, CitySquares, TeleAtlas, Navteq GPS, Judy's Book, or the like.

In another embodiment, a media entity may be a sign or billboard. A billboard may be printed, or may be presented electronically. Billboards or signs may be placed in high traffic areas, and may include static images, physical objects, video, audio content, odors, or the like. In another embodiment, a billboard may spill beyond a default billboard space. In other embodiments, a billboard may be digital, inflatable, multi-purpose, may include many different advertisements displayed at different time intervals, may not be movable, may be movable, may spin, may move up and down, or the like.

In another embodiment, a media entity may be an Internet web site. A web site may be a set of related web pages served from a single web domain, or from multiple web domains. A web site may be hosted on many different web servers, may be accessible via an Internet connection, may be available via a local network. In one embodiment, a web site may include plain text, HTML, XHTML, JavaScript, Ajax, C, C++, Python, BigTable, PHP, Erlang, JAVA, RoR, Scala, J2EE, Perl, WebSphere, Servlets, Cold Fusion, or the like.

In another embodiment, a web site may include content from another server, such as a database server, a content server, a media server, an advertising server, a database server, an RSS, or the like. A website database may include BigTable, MySQL, Microsoft SQL, PostgreSQL, Oracle, or the like. In another embodiment, a web site may be accessed via HTTP, HTTPS and may be access by a web browser, or a terminal, or the like. A website may be static or dynamic. A website may be dynamic based on a schedule, user input, other criteria

In another embodiment, a media entity may include search engine optimization (SEO). In one embodiment, SEO may include natural results where a search engine evolves based on clicked results from specific search terms. SEO may focus on image searches, local searches, video searches, academic searches, or the like. A search engine may learn preferred links depending on clicked links from a target audience (users of the search engine). A campaign manager module may affect SEO may be affected by indicating web pages that may be crawled by an internet “spider.” A campaign manager module may affect SEO by stuffing keywords and search terms in crawled pages.

In another embodiment, a media entity may include search engine management (SEM). SEM may be similarly effected as SEO. In another embodiment, SEO may include paid submissions to guarantee crawling, set fees, or indicate a cost-per-click, or pay-per-click (PPC). Additionally, SEO may include human submissions, or the like.

In another embodiment, a media entity may include social media. In one embodiment, social media may include internet forums, weblogs, social blogs, microblogs, wikis, social networks, podcasts, photographs, pictures, videos, ratings, social bookmarking, or the like.

In one embodiment, social media may operate via a mobile device. Social media may be based on point in time, geographic location, emergency transmissions, slow transmission, or the like. Social media may include advertisements, sales promotions, discounts, coupons, relationship development, rewards programs, loyalty programs, or the like. In another embodiment, social media may include identification of users, followers, names, ages, genders, sexual orientation, conversations, tweets, blogs, posts, shared media, distributed media, presence of users, location or users, interest of users, hobbies of users, connection status of users, relationships between users, social networks, family, friends, fans, group admissions, reputation, ratings, feedback, or the like.

In another embodiment, a media entity may focus on management of a reputation. Reputation management may include affecting search engines, SEO, or the like, in order to accentuate positive feedback, results, comments, or the minimize the visibility of negative feedback, results, comments, ratings, or the like. In one embodiment, reputation management may include rewarding customers that have had a positive experience with an entity, although the reward, may or may not be directly correlated with the positive feedback. In another embodiment, reputation management may include forwarding positive feedback, comments, ratings, reviews to search engines so that they may more likely be found by potential future customers, or the like.

In one embodiment, reputation management may include affecting how web sites are crawled, or preventing Internet spiders from crawling sites that may include negative feedback. For example, an entity may provide web pages for receipt of negative comments, concerns, complains, problems, or the like, but may instruct an Internet spider to not crawl these web pages. Additionally, positive feedback pages may be crawled, and include in SEO algorithms, or the like. Where legal, reputation management may also include astroturfing third party review sites, censoring negative complaints, working with customers to change negative reviews, or the like.

In another embodiment, a media entity may include email marketing, or SMS messages. Email marketing may include sending email messages to groups of people, cold lists, potential clients, customers, or the like. Emails may include advertisements, links to advertisements, business requests, solicit sales or donations, text, images, video content, audio content, attached media in a variety of formats, or the like. Emails may encourage customer loyalty, encourage repeat business, seek initial business or new customers. Emails may be transactional emails, or direct emails, or other.

SMS messages may also include similar content as email messages. In one embodiment, an SMS message may include images, text, audio, video, hashtags, or the like. An SMS message may be sent to a short code, long numbers, or other, or the like.

In another embodiment, a media entity may include advertising participation in a game or other online event. For example, in a massive multi-player online game (MMOG), promotional messages may be transmitted by players of the game. In this way, media content, or advertising content may be injected into an online event by participants. The participants may or may not be genuinely involved in the current event (e.g. they may just participate in order to advertise their products or services).

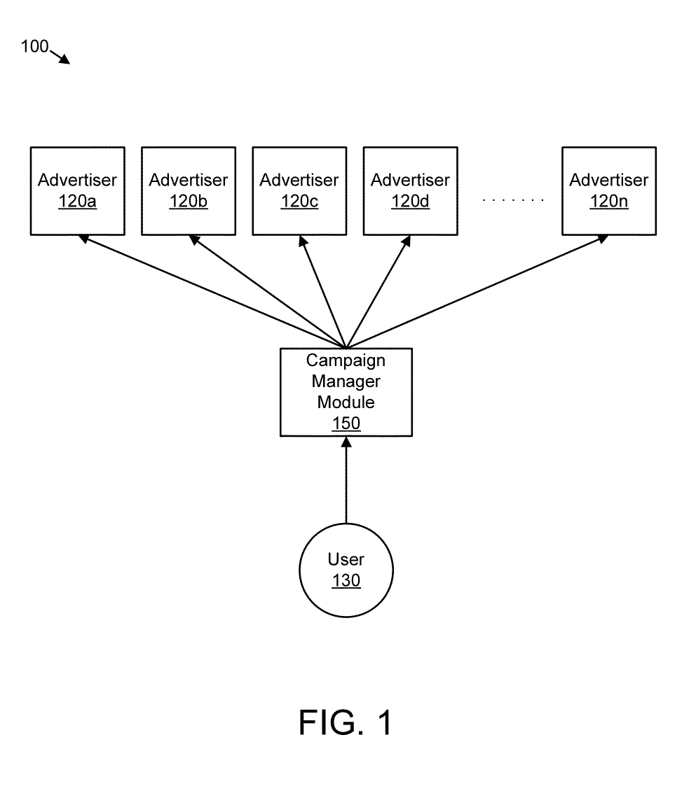

FIG. 1 is a schematic block diagram illustrating one embodiment of a system in accordance with the present disclosure. The system 100 includes a user 130, a campaign manager module 150, and a plurality of advertisers, 120. In one embodiment, a user 130 may communicate business information to a campaign manager module 150. The campaign manager module 150 may communicate advertisement to advertisers 120 based on information received from the user 130. The user may modify campaign parameters real-time, and the campaign manager module 150 may alter or effect media entities or advertisers 120 based on updated or modified campaign parameters.

As described herein, an advertiser may be any type of entity that may advocate, encourage, persuade, or manipulate another entity to purchase a product or service. An advertiser may be a person, a computing system, an apparatus, or the like. An advertiser may include wall paintings, billboards, street furniture or components, flyers, cards, radio, cinema, television, web banners, mobile screens, shopping carts, web popups, skywriting, benches, human billboards, forehead advertising, magazines, newspapers, town criers, sides of buses, banners, sides of airplanes, doors, roofs, tables, screens, stage shows, elastic bands, disposable devices, stickers, streaming media, streaming audio, streaming video, posters, event tickets, supermarket receipts, or anywhere else. Communication with an advertiser may be verbally, electronically, via print, or the like.

In one embodiment, a campaign manager module 150 may create media content for use by a media entity. A campaign manager module 150 may create a landing page, advertisements, or the like, for a website using program code executable by a processor on a computing device. The advertisements and landing page may present information, imagery, audio, video, or other media content to represent an entity and what they want to promote or advertise. A landing page for a website may include a web site as previously described. A storefront website may include various designs, color schemes, logos, trademarks, maps, directions, information, widgets, tools, promotions, or the like.

A campaign manager module 150 may display SEO tools, ecommerce, a mobile interface, a dashboard, or the like. A dashboard may display traffic information for the web site including users, hits, page views, locations of users, Internet protocol (IP) addresses, form entries, or the like. A dashboard may also include social media content. For example, a dashboard may display social reach of any previously mentioned media entities, Facebook posts, twitter tweets, or the like. A dashboard may also include results of SEO strategies, SEO status, keywords, trends, patterns, or the like. A dashboard may also display reach or effect associated with a media entity, or associated with media entities currently being used. Reach may include a count of ad impressions, clicks, online visits, mobile visits, mobile inquiries, radio listeners, radio responses, or the like.

A campaign manager module 150 may display key traffic analytics. Traffic analytics may be used to measure or estimate the effectiveness of a media entity. For example, web site traffic may be measure and correlated with advertisement via different media entities. The traffic may be analyzed to include location information, number of page hits, number of pages, or the like. Traffic may be measured at a local web site, or at an online web site. By monitoring comments, posts, blogs, or the like, communication about an entity may be estimated. Therefore, regardless of the presence of a local web site, traffic analytics may measure effectiveness of a media entity by measuring Internet traffic, or the like. Traffic analytics may also include recorded traffic analysis that may be replayed. Replayed traffic analytics may also indicate heat maps or other graphical representation of analyzed traffic.

Traffic analytics may also include web server log files, page tagging, geolocation of visitors, click analytics, customer lifecycle analytics, or the like. Potential customer click patterns, length of visit to web page may also indicate an effectiveness of a web site. In one example, increased web site visitors from customers at a specific physical location may indicate that a media entity may be more effective in that area than in other areas. In another example, geolocation of visitors may indicate higher efficiency for media entities advertising in the associated location.

A campaign manager module 150 may also provide a web client to help manage the variety of web services and capabilities described herein. For example, a set of web pages may be provided to assist a user of the web pages to create, cancel, generate, modify, schedule, delete, organize, measure, or monitor a media entity. Changes or modification via a web client, may be applied with a short time period, a few hours or faster, for example. In this example, a media entity may be stopped, started, rescheduled, or the like by a user of the web client almost immediately.

In another embodiment, a campaign manager module 150 may market hyper-locally. A campaign manager module 150 may focus or isolate a specific media entity to a small community or local physical area. Community mechanisms, interactions, cultures, religions, demographics, behaviors, trends, or the like, may be considered in order to provide a more effective local media entity. In one example, a media entity may consider GPS information at a mobile device in order to decide which advertisement or services to offer at a mobile device.

In another embodiment, hyper-local may include temporal location as well as physical location. A campaign manager module 150 may consider a time frame for an event in order to decide which advertisement to run via which media entities. For example, a campaign manager module 150 may schedule certain advertisements via certain media entities based on a popular sporting event, cultural event, holiday, day-time, night-time, evening, morning, weekdays, weekends, religious observance times, or the like.

In another embodiment, a campaign manager module 150 may provide a centralized control interface for a user. In one embodiment, a campaign manager module 150 may provide a single user interface to control, effect, manipulate, alter, schedule, cancel, begin, or other, a plurality of media entities, as previously described.

In one embodiment, a campaign manager module 150 may receive payment via electronic fund transfers, credit cards, checks, or the like. Compensation for media entities may or may not be received on a specific schedule, such as monthly, yearly, weekly, or the like.

In one embodiment, a campaign manager module 150 may allocate a form of logical currently to customers based on actual funds provided or paid. For example, a user may credit his/her account based on funds paid. In another example tokens may be used to represent an amount of credit available to a user. Credits may be used by a customer in order to allocate resources to specific media entities. As used herein, credit may include financial funds, tokens, checks, labor, or the like. In another embodiment, different media entities may require different amount of credits, at different times, at different locations, etc. Therefore, a user of a campaign manager module 150 may alter a campaign real-time by changing times of advertisements via different media entities, starting new media entities, canceling media entities, or other modifications as described herein. A user's credit may be affected based on the altered schedule of advertisements. For example, if a user schedule more advertisement for a certain media entity, that media entity may require more tokens to be allocated. In another example, if a user cancels a media entity, credits may be refunded to the user. In this example, the refunded credits may be used to start or initiate other media entities.

The number of credits required for a specific media entity may be effected based on schedule, time of day, weekday, weekend, temporal consistency with an event, such as dances, concerts, special events, holidays, or the like. In one embodiment, an interface to a campaign manager module 150 may allow a user to adjust frequency of an advertisement via multiple media entities via a single slider bar, graphical control, button, drop-down box, or the like. In one example, the slider bar may represent a frequency of advertisement with a specific advertising entity. In another example, the slider bar may represent an amount of credit to be allocated to the specific advertising entity.

In another embodiment, a campaign manager module 150 may allow a user to configure advertisements for a media entity based on personal interests, personal hobbies, cultural areas, geographic locations, specific television programs, specific television program types, genres, radio programs, radio program types (religious, sports, gardening, news, music, or the like), channels, or the like.

In one embodiment, a campaign manager module 150 may store historical configuration for a user. A user may save a current configuration, may subsequently alter the configuration of the campaign. Based on results, analytics, metrics, of the campaign, a user may choose to revert back to a previously saved configuration. For example, a set of configuration parameters may be loaded, the changes applied, and the required amount of credit automatically deducted from the users account. This may allow a user to see real-time how his/her campaign choices affect his/her available resources.

In one embodiment, a campaign manager module 150 may include derived intelligence. Derived intelligence, as described herein, includes recommend settings, configuration, media entities, schedules, or the like, based on historical success of like businesses. For example, a campaign manager module 150 may learn that certain advertisers 120 are very effective at advertising pizza parlors at a given geographic location. The campaign manager module 150 may not be aware of why the advertiser is especially successful at pizza parlors at the geographic location, but may nonetheless recommend settings consistent with what is successful. Therefore, the campaign manager module 150 may derive intelligence from historical analytics, and recommend intelligent settings to a user 130 based on the historical success.

In one embodiment, a campaign manager module 150 may publish consistent information to available business directory listings, or other modules that may communicate with business directory listings. A user may alter business information such as, but not limited to, contact information, phone numbers, addresses, employees, business leadership, hours of operation, or the like. The information may be altered via a single user interface with a campaign manager module 150. The configuration manager module may automatically publish the altered information to available business directory listings, or other modules that may communicate with business directory listings. This may allow a user, via a single interface, to update hundreds, or more, business listings with his/her contact information, or the like. Consistently updating many business directory listings via a single user interface may also ensure that information regarding the business is consistent across many listings.

In another embodiment, a campaign manager module 150 may recommend sets of configuration parameters to a user. For example, based on success of like businesses, a campaign manager module 150 may recommend a likely successful configuration of media entities for a specific region, based on historical success, or the like.

In one embodiment, a campaign manager module 150 may learn effectiveness of media entities. A campaign manager module 150 may track effectiveness of an advertiser 120, and update preferences or recommended success settings based on current effectiveness of advertisers 120. In another embodiment, the effectiveness of an advertiser may change over time. The campaign manager module 150 may monitor effectiveness of an advertiser 120 and may periodically update preferences or recommended configuration parameters for a campaign based on currently successful parameters. This may allow a user to be informed regarding trending patterns in advertising, based on current success, without having to track the success of the marketing.

In one example, a previously successful or effective advertiser 120b, may begin to show very poor results. The campaign manager module 150 may suggest to a user 130 that a different advertiser 120c may be more effective. The user 130 may alter his/her campaign via a single user interface in order to quickly divert resources to a more effective advertiser 120c. In another example, a previously unsuccessful advertiser 120a, may begin to be more effective. The campaign manager module 150 may suggest to a user 130 that the advertiser 120a, is becoming very effective. The user 130 may adjust campaign resources in order to direct more advertising resources to the advertiser 120a.

In one embodiment, a campaign manager module 150 may create advertisement automatically. Based on current slogans, trademarks, colors, products, services, templates, preferences, or the like, a campaign manager module 150 may generate an advertisement for the user 130. In another embodiment, the campaign manager module 150 may transmit user metadata to a partner, where the partner may generate an advertisement from the provided information. The campaign manager module 150 may make suggestions based on a generated advertisement from a partner. The user 130 may approve of the generated advertisement, and the advertisement may be transmitted to several advertisers 120 for distribution.

In another embodiment, a campaign manager module 150 may receive currently existing advertisements. The campaign manager module 150 may digitize received advertisements. The advertisements may be in printed form, or other hardcopy. The campaign manager module may scan, alter, manipulate, or other allow a user to do the same via a user interface. This may allow a user 130 with physical forms of advertisements, to quickly transition to an online, digital arena.

In another embodiment, a campaign manager module 150 may alert a user 130 based on an increasing amount of negative review, feedback, comments, or the like. The campaign manager module 150 may attempt to mitigate the review based on the reputation management previously described. In another embodiment, the campaign manager module 150 may receive alerts from a partner product, or receive an aggregated reputation from a partner product. The user 130 may adjust media entities, adjust advertisements, or the like, in order to address a growing negative sentiment toward the user 130 running advertisements. In one example, in response to an increasing negative sentiment toward the user 130, the campaign manager module 150 may increase advertising for associated customers. Therefore, a campaign manager module 150 may allow a user to more quickly address reputation problems. This is especially the case, when a single interface may be used to immediately affect a plurality of advertisers 120.

In one embodiment of a method, a business 130 may attend a workshop and may provide business information, logos, trademarks, contact information, industry information, or the like. The business 130 may create a web site via the campaign manager module 150, via a third party, via a partner, or the like. The campaign manager module 150 may review the information for consistency, and provide recommendations about slogans, colors, names, etc. The campaign manager module 150 may also receive recommendations for a third party, a partner, or the like. The campaign manager module 150 may publish the business information to business directory services as previously described, or may contract with a directory service to publish business information to multiple directories. The campaign manager module 150 may publish or launch a web site for the business 130, or provide a published web site, or set of web pages to be launched by a partner, hosting service, or the like. The campaign manager module 150 may publish generated keywords, search terms, or the like, with Internet search engines. The campaign manager module 150 may track keywords and search terms to verify effectiveness. The campaign manager module 150 may connect the business to a plurality of social networks, and may create accounts if necessary. The campaign manager module 150 may analyze traffic and perform analytics, review recent posts, recommend media resource allocations, create ads, select targeted demographics, geography, city, radio times, radio stations, television stations, television station types. In another embodiment, a campaign manager module 150 may disqualify or avoid certain media entities based on preferences by the business 130, reputation, perception, or the like. The campaign manager module 150 may receive a schedule of advertisement based on the aforementioned factors. The business 150 may verify that generated ads, schedules, media entities, are appropriate. The campaign manager module 150 may execute the campaign strategy, run ads on schedule, may notify media entities of start/stop dates/times. After a campaign runs for some time, as previously described, a campaign manager module 150 may monitor traffic, and recommend alterations to the campaign strategy based on traffic, historical success, marketing trends, trends of advertisers 120, or the like.

In another embodiment, the campaign manager module 150 may provide an easy selection interface for the business 130. For example, a campaign manager module 150 may provide an aggressive campaign strategy, an average campaign strategy, or a minimal campaign strategy. In this example, the business 130 may simply select one of three campaign strategies, and not be required to manage more detailed information. This may provide a business 130 with a simple single choice selection to run a complicated and integrated advertisement campaign. The campaign manager module 150 may also provide success metrics in a simplified format. For example, the campaign manager module 150 may generate a bar chart of the most successful media entities or advertisers 120. This may allow a business 130 easy easily select a few of the most efficient advertisers 120 without having to analyze metrics, values, numbers, or the like.

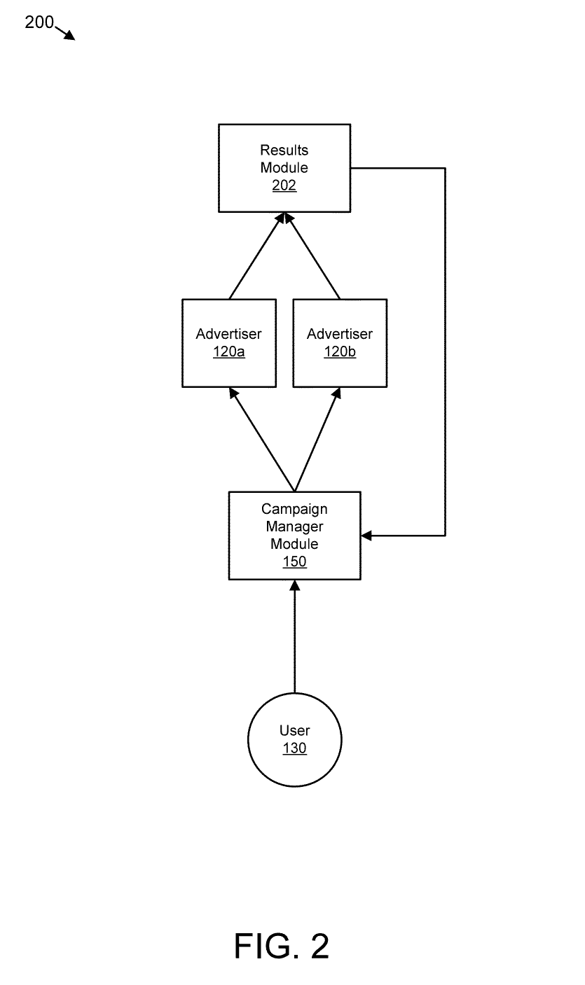

FIG. 2 is another schematic block diagram illustrating one embodiment of a system in accordance with the present disclosure. In one embodiment, a user may provide business information to a campaign manager module 150. A campaign manager module 150 may generate multiple advertisements and transmit a portion of the advertisements to advertiser 120a, and a portion of advertisements to advertiser 120b. A results module 202 may monitor and track results of the advertisers 120, and may provide feedback to the campaign manager module 150. In another embodiment, the results module 202 may receive results from many sources, and aggregate the results into a composite product. The aggregated results may be transmitted to the campaign manager module 150. The campaign manager module 150 may receive updated information from the user 130, based on the feedback from the results module 202, and alter the portions of advertisement to the advertisers 120.

In one example, feedback from the results module 202 may indicate that advertiser 120a is more successful than advertiser 120b. The user 130 may adjust the campaign strategy to shift the advertisements to advertiser 120a. This may help the user 130 be more effective in the advertisement campaign. In another embodiment, the advertisers 120 are immediately impacted based on their effectiveness. A poorly performing advertiser may lose business quickly, while a successful or effective advertiser may quickly receive additional advertising revenues. Therefore, a short flow of information between results of advertisers and decision regarding which advertisers to use, may motivate advertisers 120 to perform more effectively. This may also benefit a business 130 advertising through the campaign manager module 150.

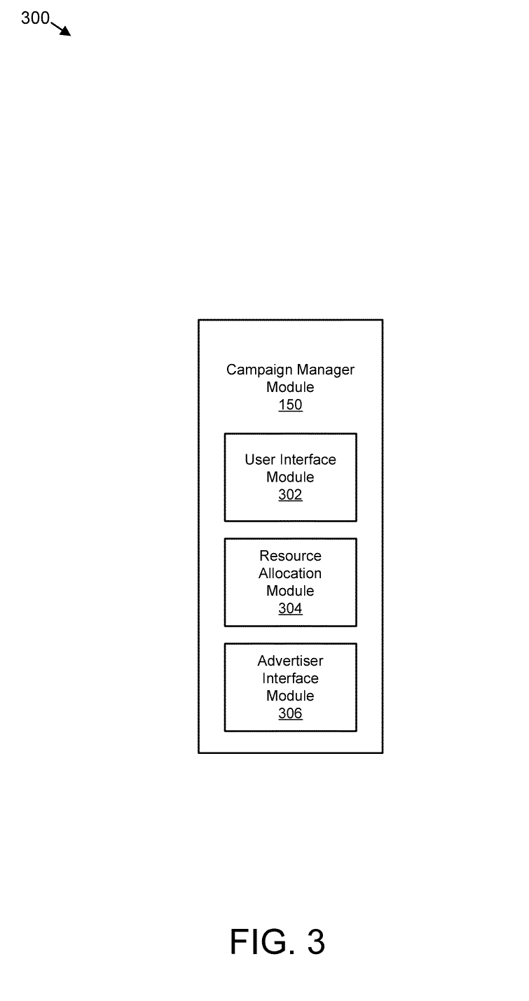

FIG. 3 is a schematic block diagram illustrating one embodiment of a campaign manager module. In one embodiment, a campaign manager module 150 may include a user interface module 302, a resource allocation module 304, and an advertiser interface module 306. The user interface module 302 may or may not perform similar functions described relative to the campaign manager module 150. The resource allocation module 304 may or may not perform similar functions described relative to the campaign manager module 150. The advertiser interface module 306 may or may not perform similar functions described relative to the campaign manager module 150.

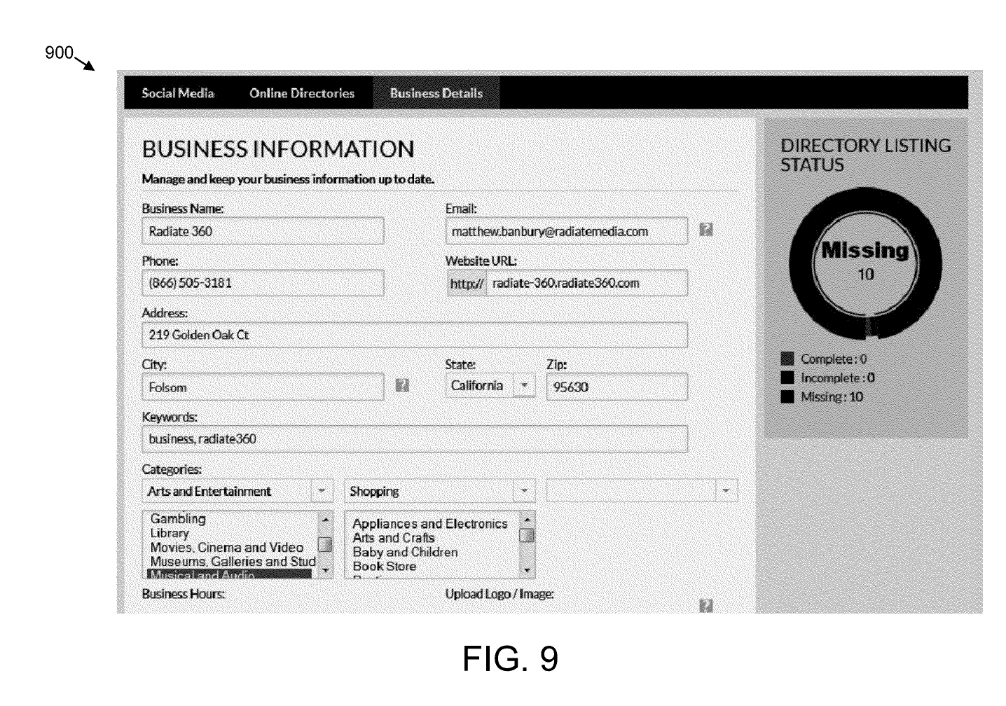

In one embodiment, the user interface module 302 may perform or manage all of the user interfaces described in regard to the campaign manager module 150. Specific example, of user interfaces are further described relative to FIGS. 9 through 16. As previously described relative to a campaign manager module 150, a user interface module 302 may provide a web interface, a software application interface, a mobile interface, or the like. Various interfaces may provide centralized control of multiple media entities or advertisers.

In another embodiment, a user interface module 302 may communicate with a user 130 to update or inform the user 130 regarding trending markets, advertiser 120 effectiveness, or the like. Communication to a user 130 may occur via email, text messages, Internet posts, or the like. Also, as previously described relative to the campaign manager module 150, the user interface module 302 may allow a user 130 to quickly divert resources to a more effective advertiser 120c. In one embodiment, the user interface module 302 may perform all of the user interfaces performed by the campaign manager module 150 described in previous embodiments. In another embodiment, the campaign manager module 150 may modify the advertisement campaign without user intervention. A configuration parameters may be used to indicate to the campaign manager module 150 whether to automatically adjust the advertisement campaign, or to simply inform the user of recommended changes.

In one embodiment, a campaign manager module 150 includes a resource allocation module 304. A resource allocation module 304 may determine how to allocate media resources to media entities or advertisers 120. In one embodiment, the user interface module 302 may command the resource allocation module 304 on how to allocate media resources. In another embodiment, a resource allocation module 304 may automatically allocate resources to media entities or advertisers 120 based on received feedback from a results module 202. Therefore, a resource allocation module 304 may stop advertising with an advertiser 120 based on poor results, or may provide additional advertising resources to another advertiser 120 based on successful results.

In another embodiment, a resource allocation module 304 may alter allocation of media resources based on a schedule as previously described relative to a campaign manager module 150. In one embodiment, a resource allocation module 304 may alter allocation of media resources based on input from a user of the user interface module 302.

In one embodiment, a campaign manager module 150 may include an advertiser interface module 306. An advertiser interface module may command the resource allocation module 304 to alter allocation of media resources based on communication with an advertiser 120. For example, an advertiser may alter conditions or costs of advertising services. In response to unexpected alterations to advertising conditions, an advertiser interface module 306 may command the resource allocation module 304 to cancel advertising with an advertiser 120. In another embodiment, an advertiser 120 may stop operations. In response to an advertiser no longer accepting advertisements, an advertiser interface module 306 may command a resource allocation module 304 to allocate media resources to other advertisers 120, without receiving confirmation from a user. In another embodiment, a resource allocation module 304 may stop advertising with a no longer operating advertiser, and notify the user 130 via the user interface module 302.

In another embodiment, an advertiser may lower prices for advertising, or change other advertising conditions. In one example, the advertiser interface module 306 may command the resource allocation module 304 to transmit a higher portion of advertisement to the advertiser that has lowered a cost of advertising, without response from a user 130. In another example, the advertiser interface module 306 may command the user interface module 302 to notify the user 130 of the changed conditions of an advertiser, and may request feedback from the user 130 before commanding the resource allocation module to altering portions of media resources to advertisers 120.

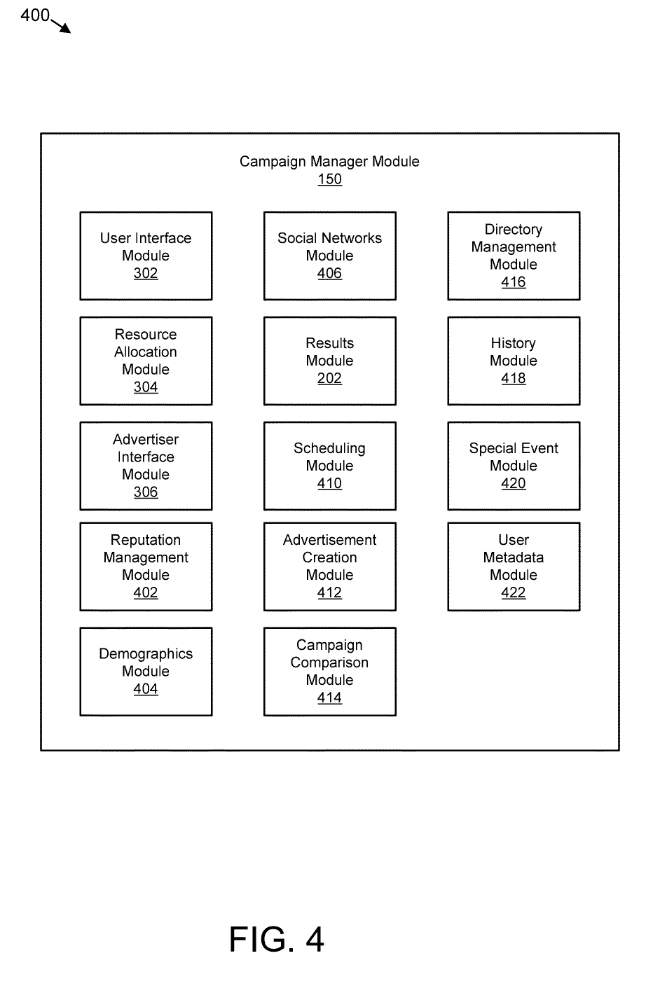

FIG. 4 is another schematic block diagram illustrating one embodiment of a campaign manager module. In one embodiment, a campaign manager module 150 may include a reputation management module 402, a demographics module 404, a social networks module 406, a results module 202, a scheduling module 410, an advertisement creation module 412, a campaign comparison module 414, a directory management module 416, a history module 419, a special even module 420, a user metadata module 422.

In one embodiment, a campaign manager module 150 may include a reputation management module 402. A reputation management module 402 may or may not perform similar functions as the campaign manager module 150.

As previously described relative to a campaign manager module 150, a reputation management module 402 may transmit information to search engines, perform SEO, accentuate or enhance positive feedback, minimize negative feedback, promote or advertise positive comments, demote or hide negative comments, or the like. A reputation management module 402 may reward customers that answer a customer survey, or the like. Information from a reputation management module 402 may motivate a user to modify a campaign. In another embodiment, a reputation management module 402 may receive negative feedback and command user interface module to limit crawling of feedback information, comments, review, ratings, etc. for a period of time. A reputation management module 402 may also provide a review of past positive comments, feedback, ratings, reviews, etc. and promote the positive elements to search engines, web crawlers, or the like. The user may also modify a current campaign based on this kind of feedback. The campaign manager module 150 may request additional funds from a user based on the campaign modifications.

In one embodiment, a campaign manager module 150 may include a demographics module 404. A demographics module may or may not perform similar functions as a campaign manager module 150. A demographics module 404 may track effectiveness of various advertising services, or media entities based on demographics. Demographics may include gender, age, ethnicity, knowledge of languages, disabilities, mobility, home ownership, employment status, location, sexual orientation, financial status, or the like.

A demographics module 404 may analyze results information and provide success metrics for particular demographic groups. For example, some advertisement may be more successful with older or younger groups, or the like.

In another embodiment, a demographics module may recommend campaign parameters based on historical success with certain demographic groups. A demographics module may learn that certain slogans, language, phrasing, imagery, colors, topics, subjects, or the like, of advertisements may or may not be more or less effective when advertising to certain demographic groups. A demographics module may recommend settings or parameters to a user 130 via a user interface module 302 in response to a user 130 identifying a certain demographic group to target in an advertisement campaign.

In another embodiment, a campaign manager module 150 may include a social networks module 406. A social networks module 406 may or may not perform similar functions as the campaign manager module 150. A social network module 406 may perform all functions related to social network previously described relative to the campaign manager module 150.

In one embodiment, a social network module 406 may create profiles for a variety of social networks. Although this disclosure is meant to include all social network sites, or to be developed networking sites, a comprehensive list cannot be practically constructed here, therefore, this disclosure cannot be limited to the following list of social network web sites: Academia.edu, aNobii, aSmallWorld, Athlinks, Bebo, BlackPlanet, Blogster, Buzznet, CafeMom, CouchSurfing, Elixio, eToro, Facebook, Faceparty, Filmow, Flixter, Flickr, Foursquare, Friendica, GamerDNA, Gather, Habbo, Hotlist, Lafango, lifeknot, LinkedIn, MeetIn, Mixi, MyLife, MyOpera, Myspace, Netlog, PartyFlock, Playfire, Plurk, Ryze, ScienceStage, Skoob, Tribe.net, Twitter, Vox, Xanga, Yammer, Yelp, Zoopa, or the like. Other social networking sites may include adult content, content inappropriate for some users, content inappropriate for some religious groups, or the like.

In another embodiment, a social networks module 406 may include monitoring posts via appropriate social network sites in order to notify the user 130 of trending patterns in advertising, or notify the user 130 of a potential reputation issue, or the like. In one embodiment, a social networks module 406 may provide metrics measuring posts about the user 130, positive posts, negative posts, neutral posts, likeability metrics, or the like. In response to receiving these metrics, a user may be motivated to modify a current campaign. In one example, on Facebook, an advertisement may receive one or more “likes,” or “dislikes.” In response to a number of dislikes, the campaign manager module 150 may discontinue the advertisement. In response to a relatively high number of “likes,” the campaign manager module 150 may increase visibility for the advertisement.

In another embodiment, a campaign manager module 150 may include a scheduling module 410. A scheduling module 410 may or may not perform similar functions as the campaign manager module 150. A social network module 406 may perform all functions related to scheduling previously described relative to the campaign manager module 150.

In one embodiment, a scheduling module 410 may alter a schedule of campaign resources, and may command a resource allocation module 304 based on a current schedule. A scheduling module may receive scheduling information from the user interface module 302. As previously described, a schedule may consider, timing of a sporting event, timing of a cultural event, holidays, day-time, night-time, evening, morning, weekdays, weekends, religious observance times, holy days, events, dances, concerts, special events, regular events, community meetings, community events, or the like.

In another embodiment, a scheduling module 410 may notify a user of a conflict of schedule. For example, scheduling rules for weekdays and holidays may not be consistent. Therefore a schedule advertisement on a holiday and a weekday may be inconsistent with each other. The scheduling module 410 may notify a user of a potential conflict. The scheduling module 410 may alter one or more schedules based on feedback form the user, or may automatically adjust or correct the potential scheduling conflict. A scheduling module 410 may also recommend schedules that have shown to be historically successful.

In another embodiment, a campaign manager module 150 may include an advertisement creation module 412. An advertisement creation module 412 may or may not perform similar functions as the campaign manager module 150. An advertisement creation module 412 may perform all functions related to advertisement creation previously described relative to the campaign manager module 150.

In one embodiment, an advertisement creation module 412 may create media content for a user 130. An advertisement creation module 412 may create a web site, web site pages, web site animations. An advertisement creation module 412 may use templates for web site creation. An advertisement creation module 412 may present designs, color schemes to a user to gauge a user's preference. An advertisement creation module 412 may receive trademarks, maps, directions, and business information to create the media content or advertisements. An advertisement creation module 412 may generate imagery, animations, audio media content, video media content, simple text, HTML, Perl, PHP, ColdFusion, and other technologies related to a web site as previously described. A generated web site may also include tools, widgets, selection boxes, buttons, or the like, in order to receive input from a user of the web site.

In another embodiment, a campaign manager module 150 may include a campaign comparison module 414. A campaign comparison module 414 may or may not perform similar functions as the campaign manager module 150.

In one embodiment, a campaign comparison module 414 may track or record estimated success of a current campaign. A campaign comparison module 414 may record a set of configuration parameters for the campaign. A campaign comparison module 414 may compare previous campaign configuration, and based on results from the results module 202, may provide feedback to the user 130 regarding which campaign configurations have been most successful. The campaign metrics may be based on campaigns focused on specific events, time frames, demographics, industries, industry categories, or the like. A campaign comparison module 414 may also recommend campaigns that have been successful for other users. Although the campaign comparison module 414 may not demonstrate why the campaigns are more successful, the campaign comparison module 414 may suggest to the user 130 certain campaign configuration based on historical success.

In another embodiment, a campaign manager module 150 may include a directory management module 416. A directory management module 416 may or may not perform similar functions as the campaign manager module 150. A directory management module 416 may perform all functions related to directories previously described relative to the campaign manager module 150.

In one embodiment, a directory management module 416 may publish relevant user 130 information to multiple directory listings as previously described. A directory management module 416 may also request records from multiple directory listings and update a directory listing, or other, if an inconsistency, or incorrect information is found.

For example, a directory listing may suffer a technical problem and lose listing information. A directory listing may recover from a backup, however the backup may not have accurate information regarding the user. A directory management module 416 may detect the inaccurate information and update the directory listing, or communicate with another module to update the directory listing based on updated information. This may limit the amount of inaccurate information about a user 130 or a business 130. Consistent information in a variety of directory listings may help a user 130 generate more business because potential customers will more easily be able to contact the business and will be less likely provided inaccurate information.

In another embodiment, a campaign manager module 150 may include a history module 418. A history module 418 may or may not perform similar functions as the campaign manager module 150. A history module 418 may perform all functions related to directories previously described relative to historical information as the campaign manager module 150.

In one embodiment, the history module 418 may record campaign parameters and correlate campaign parameters with results from the results module 202. After a user modifies a campaign, or a campaign parameters, a history module 418 may generate a new record. Over time, a history module 418 may associate sets of campaign parameters with results from the results module. This may allow a user to identify sets of configuration parameters that have been most successful in the past. A history module 418 may also correlate sets of configuration parameters with events, holidays, or other time periods in order to provide a more accurate likelihood of success for a given set of configuration parameters for a given event. A history module 418 may also provide sets of configuration parameters that have been successful for other users 130. Therefore, over time, users of the campaign manager module may receive notifications and recommendations of successful campaigns, and may apply like or similar sets of configuration parameters for their campaigns. In one embodiment, a history module may command a schedule module 410 to make modification based on historical success. In another embodiment, a history module 418 may provide a recommendation to a user 130.

In another embodiment, a campaign manager module 150 may include a special event module 420. A special event module 420 may or may not perform similar functions as the campaign manager module 150. A special event module 420 may perform all functions related to special events previously described relative to the campaign manager module 150.

In one embodiment, a special event module 420 may receive special events from a user, and may command a scheduling module 410 to temporarily alter an advertising schedule based on a special event. In another embodiment, the special event module 420 may request historical data from the history module 418 for past special events and consider historical data before recommending a schedule to the scheduling module 410. In another embodiment, the special event module 420 may recommend campaign configuration parameters to a user for a special event via the user interface module 302.

In another embodiment, a campaign manager module 150 may include a user metadata module 422. A user metadata module 422 may or may not perform similar functions as the campaign manager module 150. A user metadata module 422 may perform all functions related to user information previously described relative to the campaign manager module 150.

In one embodiment, the user metadata module 422 may receive user information or metadata via the user interface module 302. In one embodiment, the user metadata module 422 may store the user information in a database, a flat file, or other storage, or the like. The user metadata module 422 may provide user data to the directory management module 416. The user metadata module 422 may provide user data to the user interface module 302 for modification. The user metadata module 422 may provide user information for the advertisement creation module 412 to include user metadata in an advertisement.

User metadata may also include an amount of credits, or tokens a user may currently allocate. For example, a user metadata module 422 may notify a scheduling module 410 that a user no longer has available credits, and the scheduling module 410 may stop advertising with media entities or advertisers 120. In another example, a user that has been out of credits, may purchase more credits. After a user has purchased more credits, a user metadata module may command a scheduling module 410 to continue scheduling advertisement with media entities.

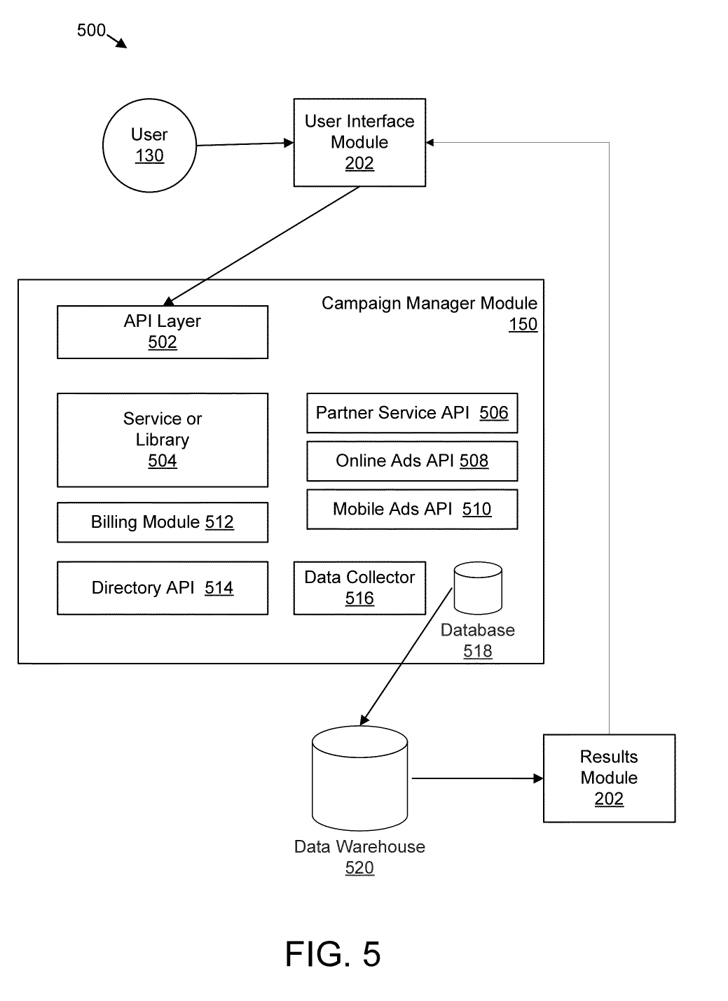

FIG. 5 is a schematic block diagram illustrating one embodiment of a system in accordance with the present disclosure. In this system 500 a user interface module 302, and the results module may operation outside the scope of a campaign manager module 150. Additionally, in one embodiment, a campaign manager module 150 may include an API layer 502, a service or library 504, a billing module 512, a directory API 514, a partner service API 506, an online ads API 508, a mobile ads API 510, a data collector 516, and a database 518. The system 500 may also include a data warehouse 520. A partner service API 506 may include an API to any type of advertiser that may communicate via an API.

In the depicted embodiment, the campaign manager module 150 includes an API layer. An API layer, as disclosed herein includes, a protocol intended to be used to allow a software application or a component of a software application to communicate with another software application or a component of another software application. In one embodiment, a user interface module 302 may programmatically communicate with a campaign manager module 150. For example, a user interface module 302 may receive user 130 input via a web page on a web server. A software component on the web server, may programmatically configure the campaign manager module 150 in order to organize and instantiate the required schedule, directories, advertisements, etc. for an advertisement campaign.

In one embodiment, the campaign manager module 150 includes a service or library 504. A service or library may communicate with other services or libraries via an API, such as, but not limited to a partner service API 506, an online ads API 508, a mobile ads API 510, or the like.

In one embodiment, a partner service API 506 may allow the campaign manager module 150 to communicate campaign configuration parameters to partnered media advertising services. Therefore, a user may still configure only one campaign, however the campaign may be programmatically transmitted to other advertising services without the user having to communicate with the partner services. A partner service may further communicate campaign parameters to other partner services, such as, but not limited to, web hosting, directories, social network, or the like.

In another embodiment, the service or library 504 may communicate with an online ads API 508. As previously described regarding the partner service API 506, a campaign manager module 150 may communicate with a provider of online advertisements via an online ads API 508. This kind of API 508, may allow a campaign manager module 150 to programmatically communicate advertisements, logos, slogans, images, videos, or the like, to media entities that create, generate, disseminate online advertisements. Because of an API, a user need not configure, or be aware that certain advertisement are being transmitted to other advertising services. This may allow a user to take advantage of a variety of other services without the user needing to understand how the other services operate.

In another embodiment, the service or library 504 may communicate with a mobile ads API 510. As previously described regarding the partner service API 506, a campaign manager module 150 may communicate with a provider of mobile ads via a mobile ads API 510. This kind of API 510, may allow a campaign manager module 150 to programmatically communicate advertisements, logos, slogans, images, videos, or the like, to media entities that create, generate, disseminate mobile advertisements. Because of an API, a user need not configure, or be aware that certain advertisement are being transmitted to other advertising services. This may allow a user to take advantage of a variety of other services without the user needing to understand how the other services operate, as previously described.

In another embodiment, the service or library 504 may communicate with a directory API 514. As previously described regarding the partner service API 506, a campaign manager module 150 may communicate with a provider of a business directory via a directory API 514. This kind of API 514, may allow a campaign manager module 150 to programmatically communicate business information, contact information, phone numbers, emails, hours of operation, maps, directions, or the like, to directory services that maintain business directories. Because of an API, a user need not configure, or be aware that certain information is being transmitted to other advertising services. This may allow a user to take advantage of a variety of business directories without the user needing to understand how the other services operate, as previously described.

In another embodiment, the campaign manager module 150 may include a billing module 512. A billing module 512 may communicate with the user interface module 302 to notify a user when a bill is due. In another embodiment, a billing module 512 may be configured to bill a client automatically. In another embodiment, a billing module 512, may automatically draft funds from an account of a user 130. In another embodiment, a billing module 512 may provide reduced bills based on loyalty, contracts, additional services, complaints, or the like. In another embodiment, a billing module 512 may not bill a user, but allow a user use of services with compensation.

In one embodiment, a campaign manager module 150 may include a database 518 for storing directory information, created advertisements, sets of configuration parameters, historical data, or the like. In another embodiment, any of the other modules defined herein may use the database 518 to store associated information.

In another embodiment, the system 500 includes a data warehouse 520. A data warehouse 520 may be physically located at a different location, may be a file server, may be a web server, may operation via Internet, or via a cloud. The data warehouse may also track and record traffic, reach, page hits, Internet posts, comments, feedback, and other relevant information regarding the user of the campaign manager module 150.

In another embodiment, the results module may read data from the data warehouse. In another embodiment, the results module 202 may data mine, or apply various data mining techniques to data residing in the data warehouse 520. The results module 202 may then provide results to the user interface module 302 as previously described.

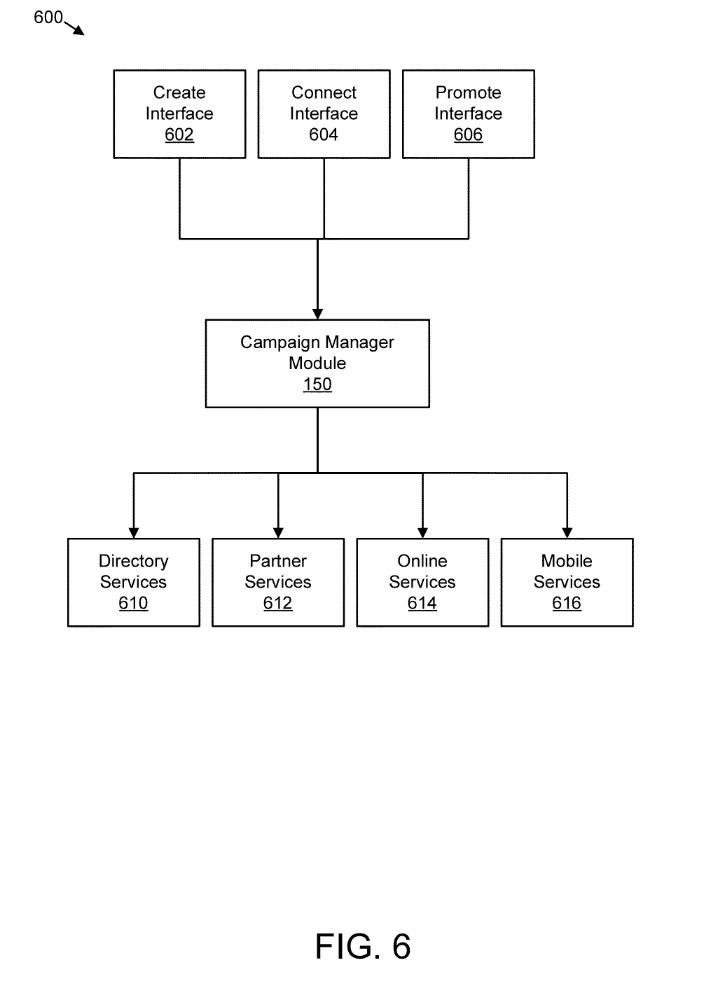

FIG. 6 is a schematic block diagram illustrating one embodiment 600 of a system in accordance with the present disclosure. In one embodiment, a user interface module 302 may be divided into several other modules, such as a create interface module 602, a connect interface module 604, a promote interface module 606, and an advance interface module 608. In the depicted embodiment, a campaign manager module 150 may communicate with the other depicted modules for various reasons as described below.

A create interface module 602 may or may not be substantially similar to a user interface module 302. A create interface module 602 may interact with a user to help create a web presence (website). A create interface module 602 may assist a user to create a web site, web pages, mobile interfaces, advertisements, schedule advertisements, setup accounts with social networks, directories, or the like. A create interface module may receive from a user sets of configuration parameters.

A connect interface module 604 may or may not be substantially similar to a user interface module 302. A connect interface module 604 may help a user connect to their customers over social network, online directories, email, or the like. A connect interface module 604 may assist a user to establish a social networking presence, synchronize with business listings, begin building a reputation, establish search terms and keywords and begin establishing a digital presence with various search engines.

A promote interface module 606 may or may not be substantially similar to a user interface module 302. A promote interface module 606 may assist in the management of campaigns, automatically create ads, web ads, mobile ads, online ads, television ads, radio ads, or the like, and may provide an easy interface for a user to use in order to begin sending advertisement to media entities. A promote interface 606 may also recommend coupons, discounts, special events, short-form broadcasts, or the like, to help promote the user or business in a specific area or time, as previously described.

In another embodiment, a promote interface module 606 may ensure that words, expressions, sounds, or the like, are consistent with allowable expressions in a media entity. For example, a promote interface module 606 may not allow a radio advertisement to say “We're the best!” A promote interface module 606 may be modified as acceptable standards change for a specific media entity.

A campaign manager module 150, based on information received from the various interfaces 602, 604, 606 begin transmitting advertisement or scheduling advertisements with media entities, such as, but not limited to, directory services 610, partner services 612, online services 614, and mobile services 616.

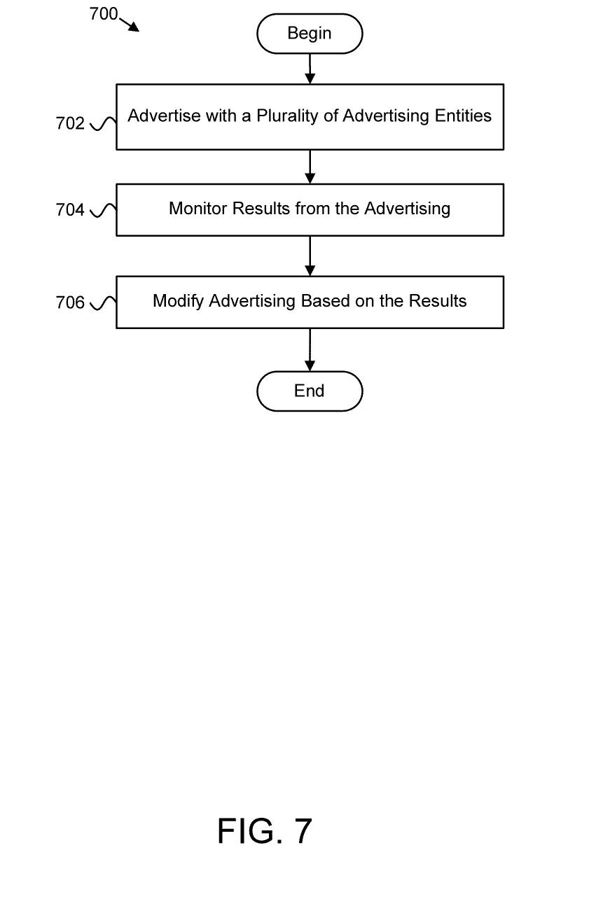

FIG. 7 is a flow chart diagram illustrating one embodiment of a method 700 in accordance with the present disclosure. The method 700 begins and a campaign manager module 150 may advertise 702 based on an advertising campaign. The advertising campaign may include one or more advertising entities. The advertising campaign may be based on a set of configuration parameters. The results module 202 may monitor 704 results of one or more of the advertising entities. The campaign manager module may modify 706 one or more of the configuration parameters based on the results and the method may end.

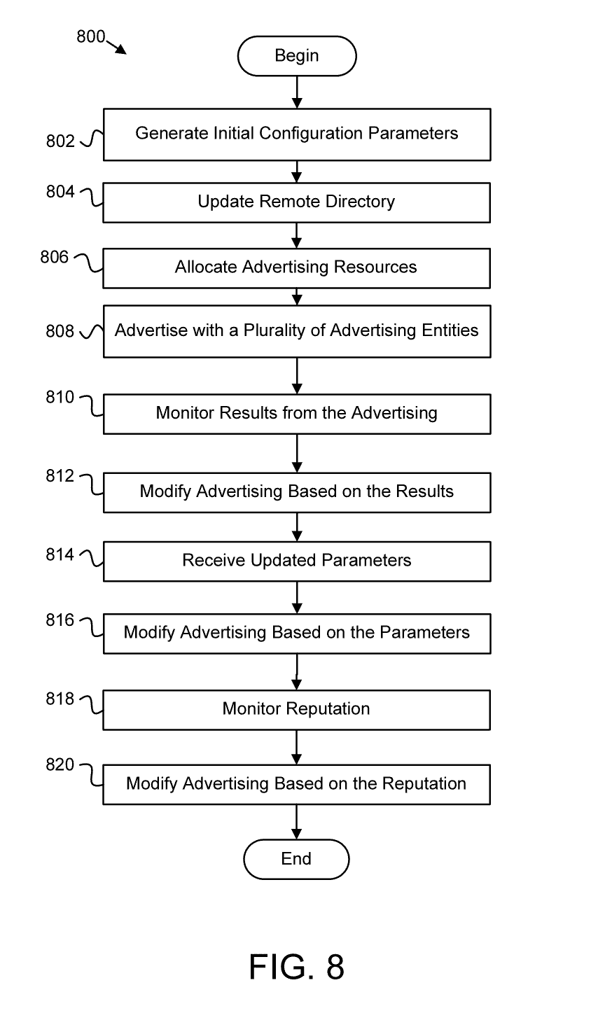

FIG. 8 is a flow chart diagram illustrating another embodiment of a method 800 in accordance with the present disclosure. The method 800 begins and a campaign manager module 150 may generate 802 an initial set of configuration parameters. In one example, the initial set of configuration parameters may be based on a similar advertising campaign. In another example, the initial set of configuration parameters may be received from a user interface. The campaign manager module 150 may updates 804 one or more remote directories. The campaign manager module 150 may allocates 806 advertising campaign resources based on available credit.

The campaign manager module 150 may advertise 808 based on an advertising campaign. The advertising campaign may include one or more advertising entities. The advertising campaign may be based on a set of configuration parameters. The results module 202 may monitor 810 results of one or more of the advertising entities. The campaign manager module 150 may modify 812 one or more of the configuration parameters based on the results. The campaign manager module 150 may receive 814 updated configuration parameters and may modify 816 the advertising campaign based on the updated configuration parameters. The campaign manager module 150 may monitors 818 a reputation and may modify 820 one or more of the configuration parameters based on the reputation.

FIG. 9 is an illustration depicting one embodiment 900 of a user interface in accordance with the present disclosure. In this depicted embodiment, a user interface module 302 presents an interface for a user to enter user metadata. The metadata may include a business name, a phone number, an address, a city, key search terms or keywords, industry categories, email address, websites, state, zip codes, or the like.

The campaign manager module 150 may update one or more directories with the provided metadata. The campaign manager module 150 may perform SEO based on the keywords provided in the interface 900. In another embodiment, the campaign manager module 150 may or may not consider a location of the user in order to perform locale specific advertising using the location of the user or business to be advertised.

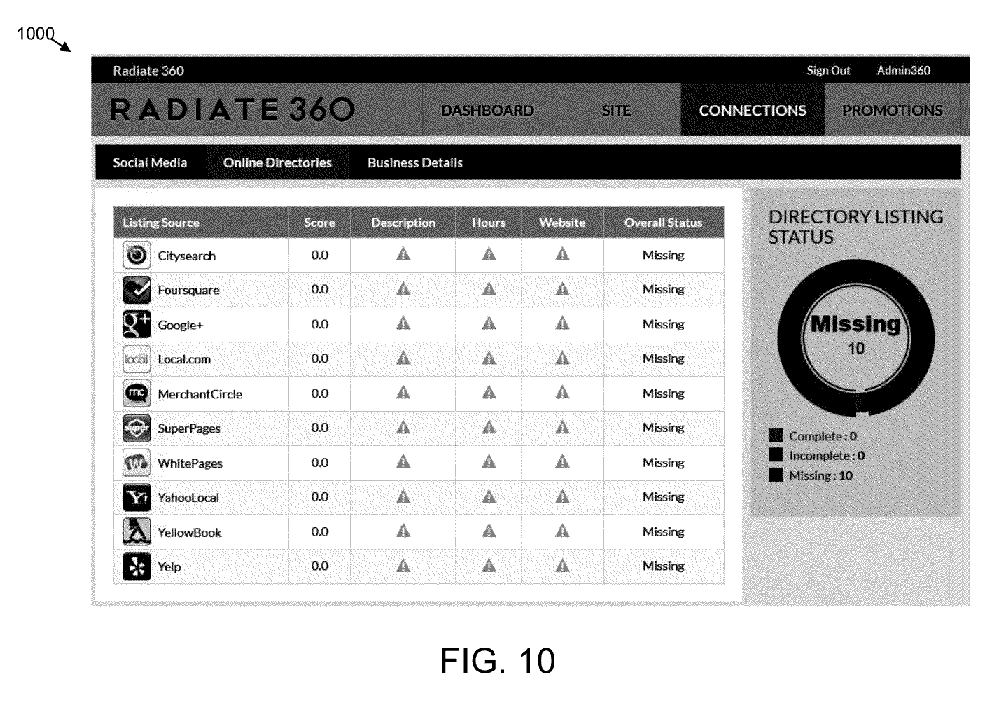

FIG. 10 is an illustration depicting one embodiment 1000 of a user interface in accordance with the present disclosure. In this depicted embodiment 1000, a user interface module 302 presents a summary page for a plurality of business directories. In the depicted embodiment, the display may present a score, description, time, website, and overall status for multiple directory listings. This may allow a business owner 130 to see how his/her business is represented via the directory listings in one simple interface.

In one example, a first directory listing may include correct operating hours for the user, while a second directory listing may include incorrect operating hours for the user. The user interface may indicate that the first directory listing includes correct hours while the second directory listing may include incorrect hours. This may allow a user of the interface 1000 to determine which business listing includes correct information and which one does not. Furthermore, the campaign management module 150 may update the second directory listing.

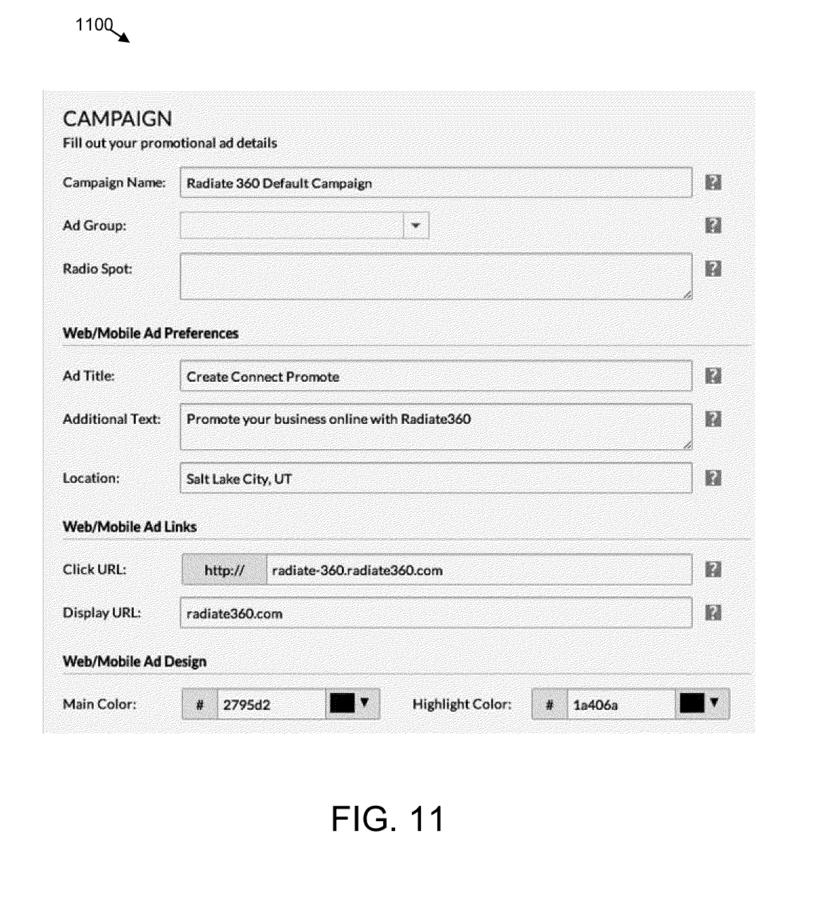

FIG. 11 is an illustration depicting one embodiment of a user interface in accordance with the present disclosure. In the depicted embodiment, an example interface for a user is demonstrated. In this example, a user may manipulate a variety of configuration parameters for the campaign, including, but not limited to, campaign name, ad group, radio spot, ad titles, additional ad text, location, URL's (universal resource locators), etc.

In one example, a user may enter a name of the advertising campaign, such as, “New Product Ads.” The user may enter an advertisement group such as “Product A.” Of course, one skilled in the art may appreciate other names or values that may be used for the various inputs provided in the interface 1100.

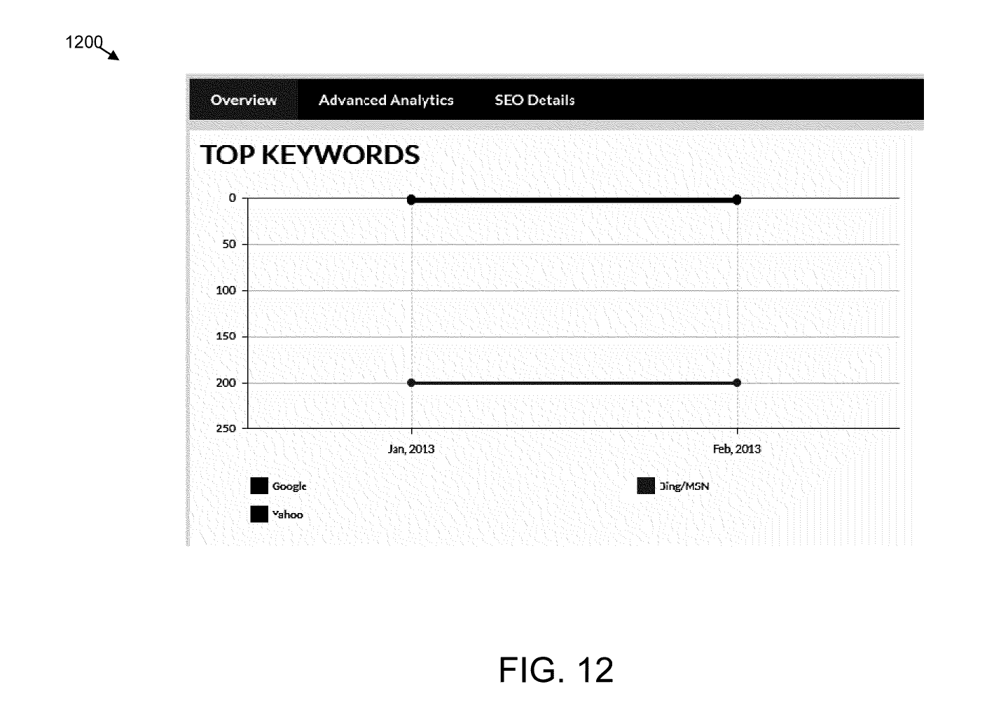

FIG. 12 is an illustration depicting one embodiment of a user interface 1200 in accordance with the present disclosure. In the depicted embodiment, an example interface is demonstrated. In this example, a user 130 may be shown top keywords associated with the user 130. In this example, various search engines are presented via different colors, and a chart is presented to indicate which search terms were most searched for with the associated search engines. A user 130 may be able to alter the display by adding or subtracting individual search engines.

In one example, in a month of February, 2012, Google™ may return a link to the user in a top 150 returned results from a search. In a month of March, 2012, Google™ may return a link to the user in a top 200 of returned results form a search. In another example, the interface 1200 may depict many different search engines concurrently. In response to one search engine returning fewer associated keywords than other search engines, the campaign manager module 150 may communicate with the search engine to increase the associated keywords.

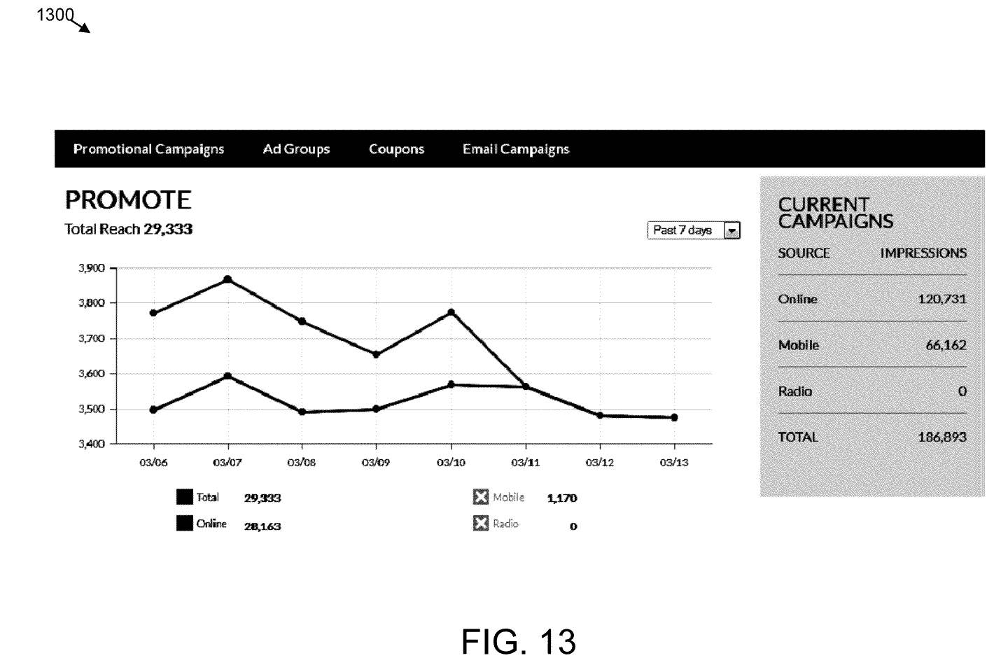

FIG. 13 is an illustration depicting one embodiment of a user interface 1300 in accordance with the present disclosure. In the depicted embodiment, an example interface is demonstrated. In this example, the user interface module 302 may display reach metrics to the user 130. For example, a chart may demonstrate a number of responses based on online advertisements, mobile advertisements, radio advertisements, or other media entities. A total number of responses may also be charted. Therefore, in one easy interface, a user may estimate how successful certain advertisements are succeeding, and may adjust campaign configuration parameters accordingly. In one example, where online advertisement demonstrate a high efficiency than mobile advertisements, the campaign management module 150 may divert additional campaign resources to the online advertisements.

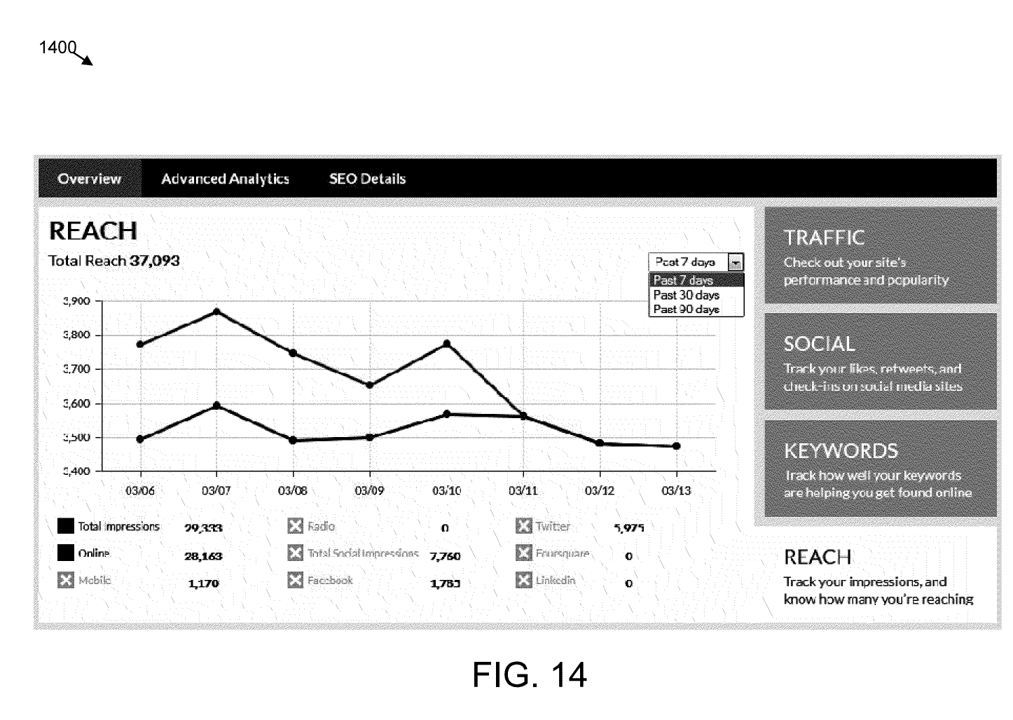

FIG. 14 is an illustration depicting one embodiment of a user interface in accordance with the present disclosure. In the depicted embodiment, an example interface is demonstrated. In this example, a user 130 may be shown impressions based on the different advertising services being implemented. In this example, a user may select a time period to see a count of impressions, such as, but not limited to, 7 days, 30 days, 90 days, or more. A chart may demonstrate the number of impressions and may color correlate them to individual media entities, such as radio, Facebook™, Twitter™, Foursquare™, LinkedIn™, or the like. A user may additionally, select or deselect certain sources of impressions via the interface.

In one example, the user interface module 302 may display total impressions, online impressions, and may not display other media entities, such as, but not limited to, mobile impressions, radio impressions, total social impressions, Facebook™ impressions, Twitter™ impressions, FourSquare™ impressions, and/or LinkedIn™ impressions. The user interface 1400 may display an ‘X’ neighboring media entities that are not currently being displayed, and may display a color associated with media entities that are currently being displayed and may display values in the chart in the respective color associated with the media entity.

In another embodiment, the user interface module 302 may provide a drop down box for a user to select a time period to display results. For example, a drop down box may include a 7 day, a 30 day, and a 90 day period. In response to the user selecting one of the display periods, the user interface module 302 may generate a chart depicting the requested information over the indicated time period in the drop-down box. Of course, one skilled in the art may appreciate other time periods and this disclosure is not limited in this regard.

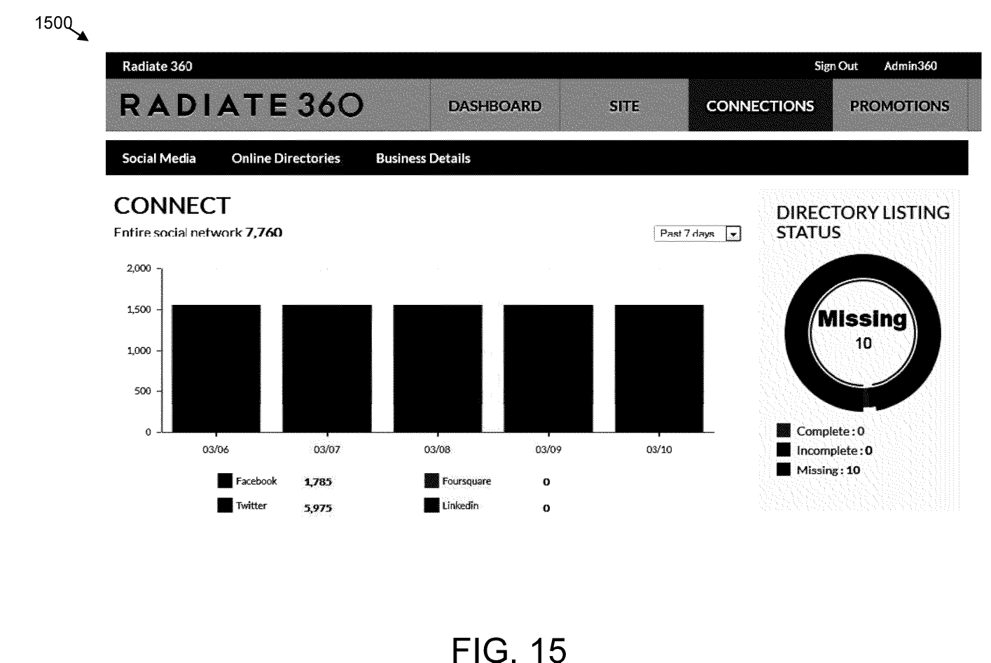

FIG. 15 is an illustration depicting one embodiment 1500 of a user interface in accordance with the present disclosure. In the depicted embodiment 1500, an example interface is demonstrated. In this example, a user 130 may be shown a bar chart indicating a successful reach to a variety of social networks. A user may select or deselect social network to be charted, and may select different time periods to display as previously described regarding FIG. 14. A secondary display may also indicate areas that may need attention. In this example, there are no directory listings for the current user. Therefore, the user interface may indicate to a user 130 regarding a deficiency, and the user 130 may be motivated to correct the deficiency. In another example, the campaign manager module 150 may automatically update one or more directories without user intervention.

Additionally, in this embodiment, a header may be displayed allowing a user to shift to other pages including a dashboard page, a web site page, a connection page (depicted in FIG. 15), and a promotions page.

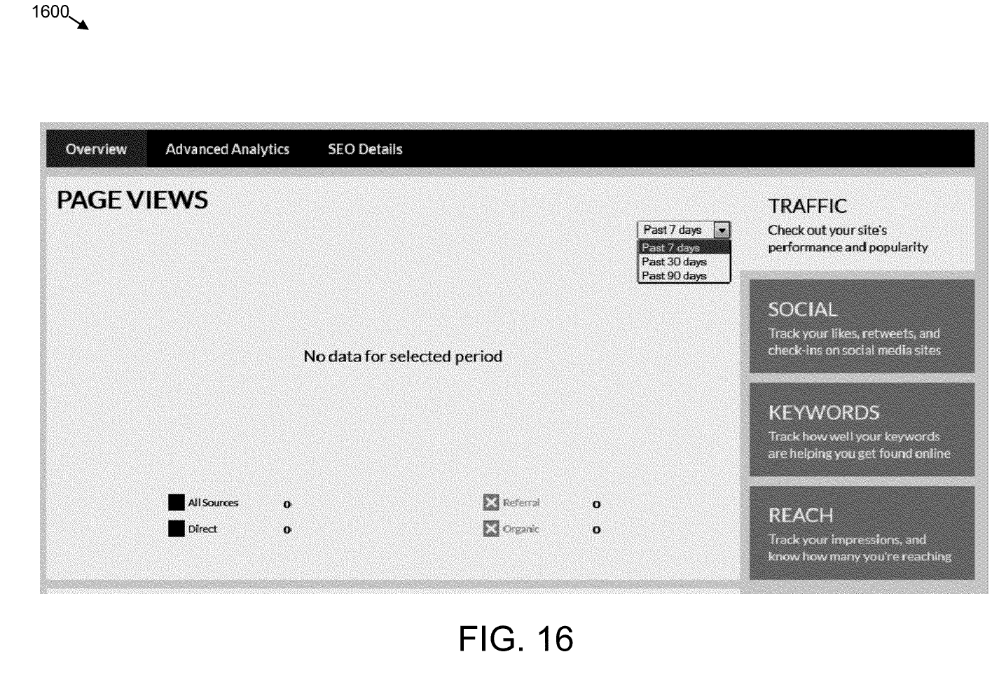

FIG. 16 is an illustration depicting one embodiment 1600 of a user interface in accordance with the present disclosure. In the depicted embodiment, an example interface is demonstrated. In this example, a user 130 may be shown a chart estimating traffic for your presence. In one embodiment, the display may indicate an amount of traffic from a variety of different sources. The interface may also indicate which traffic is from referral, and which traffic is organic as one skilled in the art may appreciate. The interface may display traffic in a graph, a bar chart, numerically, or the like. As disclosed herein, organic traffic is traffic generated that may not be associated with paid services. Organic traffic may be generated or increased by transmitting information to directories, search engines, guides, or the like.

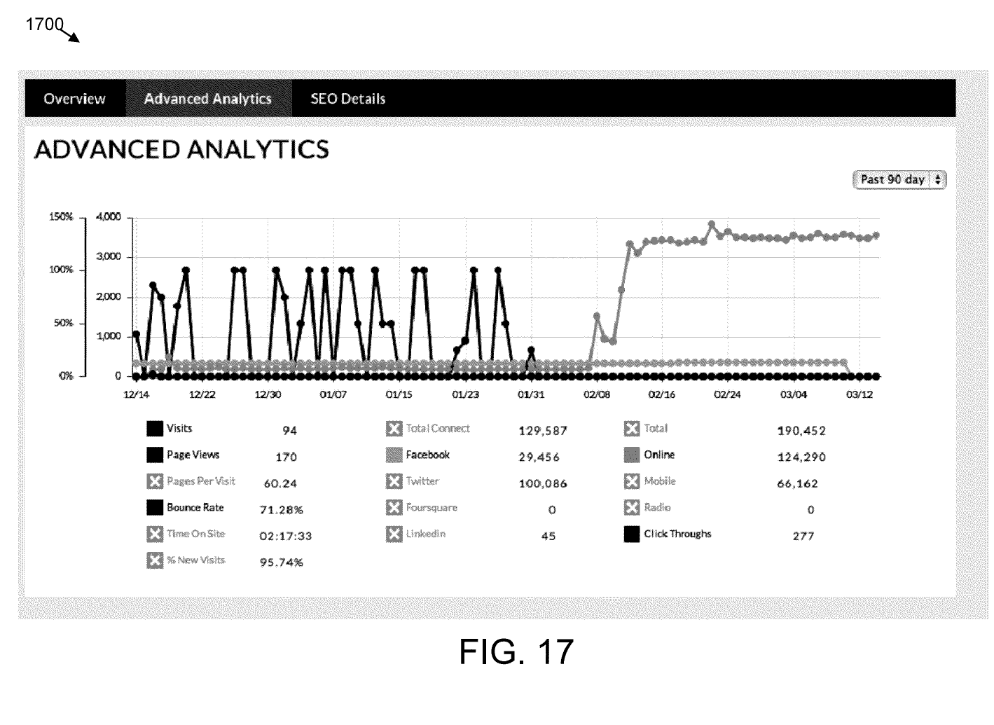

FIG. 17 is an illustration depicting one embodiment 1700 of a user interface in accordance with the present disclosure. In the depicted embodiment, the user interface module 302 may construct or provide an advance analytics display. The user interface module 302 may aggregate success metrics from multiple media entities and provide a composite display displaying web page visits, page views, pages per visit, bounce rates, connection counts, Facebook posts, Twitter tweets, Foursquare results, LinkedIn posts, total hits, total online references, click-throughs, or other, or the like. These various metrics may be presented via a single chart include multiple axes.

In one embodiment, the results module 202 may receive results from a television broadcast media entity. In one embodiment, results from a television broadcast media may be based on a television rating for a television program associated with a television advertisement. For example, a Nielsen rating for the television program may be used to estimate a reach of a television advertisement.

In another embodiment, a television broadcast program that includes a television advertisement may be transmitted to many digital devices capable of displaying the television advertisement. The results module 202 may receive a specific number of devices that have received the television broadcast signal.

In one embodiment the results module 202 may track a performance metric such as, but not limited to, sales, inquiries, phone calls, emails, web page hits, web page visits, web page pages per visit, bounce rates, click-through counts, time on a web page, connection counts, twitter tweets, blog posts, social media posts, or the like, that occurred at a similar time associated with a television advertisement. The similar time may be minutes, hours, days, months, or more. In another embodiment, the performance metric may be associated with a particular demographic. For example, a business metric may be associated with people having a similar or different marital status, race, religion, age, gender, size, height, weight, body type, medical condition, or the like. The results module 202 may correlate the reach of a television advertisement with an increase in a performance metric. The results module 202 may calculate an efficiency by comparing the cost of a television broadcast media entity with an associated increase in a performance metric.

In one embodiment, the results module 202 may receive results from a radio broadcast signal. The results module 202 may estimate a reach of a radio broadcast signal based on ratings, such as diaries, Nielsen ratings, digital technologies, or the like. In another embodiment, the results module 202 may measure a number of devices that have digitally received the radio broadcast signal.

In one embodiment, the results module 202 may track a performance metric associated with a period in time, as previously described, of the radio broadcast signal. In another embodiment, a promotional code may be provided in the radio broadcast signal. The results module may measure responses based on usage of the provided promotional code. The results module 202 may calculate an efficiency by comparing the cost of a radio broadcast media entity with an associated increase in a performance metric.

In one embodiment, the results module 202 may receive results from a printed media entity. A printed media entity may include newspapers, magazines, journals, billboards, posters, or the like. The results module 202 may estimate a reach of the printed media entity. In one embodiment, a simple frequency may be estimated. In another embodiment, an average exposure frequency may be estimated. Gross ratings points (GRP's) may be estimated by comparing the impressions delivery of a schedule to a target universe size. For example, one million gross impressions may be 100 GRP if a target size is one million. In one embodiment, an average frequency may be calculated by dividing GRP's by a reach. A number of impressions may be estimated by multiplying a number of persons reached by an advertisement with a frequency of that person's exposure. In another embodiment, the results module 202 may estimate an efficiency of a printed media entity by associating an increase in a performance metric associated with a time period wherein the printed media was distributed. An efficiency may be calculated by dividing a cost of a printed media entity by a difference in a performance metric associated with the printed media entity.

In one embodiment, the results module 202 may receive results from a business listing service. After a business listing directory service is used, the results module 202 may verify correct listing information with several business listings to determine an effectiveness of the business listing service. The results module 202 may determine an effectiveness by dividing a number of correct business directory listings by a number of incorrect business directory listings. In another embodiment, an effectiveness may be calculated by measuring a performance metric associated with a period in time the business listing service was in use. The results module 202 may calculate an efficiency by comparing results of a business listing services with an associated business listing effectiveness.

In one embodiment, the results module 202 may receive results from an Internet web site. A results module 202 may associate a performance metric with a period of time during which an Internet web site had been enhanced, altered, modified, or the like.

In one embodiment, a results module 202 may receive results from a media entity employing search engine optimization, or search engine management. A results module 202 may measure search engine optimization by searching a set of search engines manually, receiving results via another server, another analytics server, or the like. The results module 202 measure an effectiveness by determining a priority order of a client based on a searched term via a search engine. For example, if a client is the first returned match based on a keyword search, the results module 202 may determine a very high efficiency. In another example, if a client is not returned in the top 100 links from a keyword search via a search web site, the results module 202 may determine a low efficiency. In one embodiment, the results module 202 may calculate an efficiency by measuring a difference in a performance metric associated with a period of time during which a search engine management media entity had been used.

In one embodiment, a results module 202 may receive results from a social media entity. A results module 202 may measure a difference in a performance metric associated with a period in time during which a social media entity had been employed. A results module 202 may determine an efficiency by dividing a cost of a social media entity by the difference in a performance metric. The efficiency may also be calculated based on one or more social media web sites used by the social media entity.

In one embodiment, a results module 202 may receive results from an email, or SMS service. A results module 202 may measure email or responses. In another embodiment, an email or SMS message may include a promotional code. The results module 202 may determine an efficiency by measuring replies to an email or SMS message. In another embodiment, the results module 202 may determine an efficiency by determining a number of responses that cite the provided promotional code. In another embodiment, the results module 202 may calculate a difference in a performance metric associated with a period of time during which an email or SMS service had been employed, or afterwards.

In one embodiment, a results module 202 may receive results from an advertisement media entity for games, online meetings, online chat groups, blogs, article comments, or the like. The results module 202 may measure a difference in a performance metric associated with a period of time during which the advertisement service had been employed.

In one embodiment, analytics may include results or ratings from a combination of one or more of the aforementioned media entities. The services may be similar types, or different types. For example, the results module 202 may combine results from more than one television media entities. In another example, the results module 202 may combine results from a television media entity, and a radio media entity.

The results module 202 may aggregate efficiency results from more than one media entity. In one embodiment, the results module 202 may measure an efficiency for one media entity as previously described. In another embodiment, the results module 202 may measure a difference in a performance metric based on the multiple media entities. The results module 202 may scale efficiency values for different media entities, depending on historical trends, or the like. For example, difference in performance metrics may be expected based on market trends, holidays, weekends, seasons, or the like. Therefore, in a scenario where an expected increase in a performance metric (i.e. sales proceeding a Christmas Holiday, or the like) a results module 202 may scale down a calculated efficiency. In another embodiment, a results module 202 may scale up, aggregate, add, subtract, divide, multiply, or the like, based on current, known, or expected trends in a performance metric. By modifying trends in a performance metric, a results module 202 may better isolate effects of one or more media entities on a performance metric.

In one embodiment, an advertisement campaign may implement different advertisements for different media entities. In another embodiment, an advertisement campaign may implement a similar advertisement in different media entities. As previously described, a results module 202 may aggregate results of the media entities, or may measure a difference in a performance metric for a period of time associated with the advertisement campaign.

In a further embodiment, a history module 418 may track and record sets of media entities being used with associated differences in performance metrics. Over time, a history module 418 may be configured to provide a combination of media entities that have best effected a performance metric. In one embodiment, the results module 202 may derive intelligence based on historical results from the history module 418. In one example, a combination of billboards and radio advertisements may be most successful in a certain city. Therefore, a history module 418 may indicate that a combination of billboards and radio advertisement may be most effective in further advertisement efforts for the certain city. The history module 418, or the results module 202 may determine an effective combination of media entities based on historical performance and not based on other factors.

In one embodiment, the history module 418 may track historical results based on geographic location. In another embodiment, the history module 418 may track results based on urban areas, rural areas, latitude, longitude, states, countries, counties, markets, industries, or the like. For example, the history module 418 may track historical results for the food industry separate from historical results for the medical services industry. In another embodiment, the history module 418 may track historical results based on special events, holidays, weekends, seasons, times of a day, or the like.

In one embodiment, the history module 418, or the results module 202 may identify a shift in historically successful advertisement campaigns. For example, where once the most successful advertisement campaign included internet advertisements and search engine optimization, the history module 418 may recognize that in recent periods, web sites, and radio advertisements are becoming more successful than Internet advertisements and search engine optimization. The history module 418 may recognize shifts, changes, or the like, in marketing trends, independent of industries, markets. For example, a successful marketing trend in pizza parlors may be recognized independent of Italian restaurants in general. The history module 418 may recommend a change in an advertising campaign to the user interface module 302 for other pizza parlors in an area, market, industry, radius, or the like, based on the recognized trend or shift.

In one embodiment, the user interface module 302 may communicate with the campaign comparison module 414 to identify differences between a current campaign configuration and a recommended campaign configuration based on an identified shift in a market trend as previously described. The user interface module 302 may receive the differences and recommend modification to current campaign configuration parameters to accommodate the identified successful trend in advertising.

In one embodiment, the history module 418 may identify historical trends in advertising markets based on geographic location. In one example, the history module 418 may distinguish between historical trends in California and historical trends in Utah. In another embodiment the results module 202 may recognize a pattern in historical trends between two or more geographic locations after a period of time. For example, a results module may determine that historical trends in California may similarly occur in Utah two years after the recognized trend in California. In another embodiment, the results module 202 may recognize similar trends in various industries, markets, locations, cities, or the like.

In one embodiment, the results module 202 may recognize a pattern in successful campaign configuration parameters between two or more locations, markets, industries, cities, counties, or the like. The results module 202 may recommend modifications to an advertising campaign in a target location based on an identified historical trend in a source area. In one example, a successful set of configuration parameters for an advertising campaign in the medical industry in Texas may be recognized. The history module 418 may have identified a time period of one year between when sets of configuration parameters are successful in Texas, and when similar sets of configuration parameters are successful in New Mexico, for example. The results module 202 may recommend modifications to campaign configuration parameters in New Mexico, approximately one year after the historical trend in successful campaign configuration parameters occurred in Texas. The results module 202 may recommend modifications to campaign configuration parameters regardless of whether the trend in the target area has been identified or recognized.

In another embodiment, the history module 418 may identify trends in successful campaign configuration parameters associated with a historical event. In one example, the history module 418 may recognize that a set of campaign configuration parameters are particularly successful following a natural disaster, such as, but not limited to, a tornado, hurricane, earthquake, flood, or the like. The results module 202 may recommend modifications to a set of campaign configuration parameters in a target area where a natural disaster had occurred based on a historically recognized pattern in successful campaign configuration parameters in other areas, where other natural disasters had occurred.

In other embodiments, the history module 418 may identify trends in successful campaign configuration parameters based on cultural events, such as cultural progress, milestones in racial equality, progress in gender equality, political progress, election results, potential new laws, new laws, religious events, religious leadership changes, or other culturally or religiously significant points in time. For example, a history module 418 may recognize a particularly success set of campaign configuration parameters following the election of a new Pope. Following the election of a subsequent Pope, the history module 418 may recommend modification to a set of campaign configuration parameters that have shown to be successful during the election of the previous Pope. Of course, this disclosure is not limited to any particular religion and one skilled in the art may recognize a culturally or religiously significant event related to other religions, cultures, or the like, and this disclosure is intended to cover all such recognizable events. Similarly, the history module 418 may recognize successful sets of campaign configuration parameters associated with government holidays, religiously significant days or events, sporting events, political events, worldwide events, or the like.

In one embodiment, a campaign manager module 150 may receive media advertisements from a client. Media advertisements from a client may include, television commercials, radio advertisements, logos, trademarks, service marks, certification marks, images, animated images, text based advertisements, electronic documents, databases, lists, music, or the like. A client may indicate preferred target audience for the media advertisements. The client may indicate a radius, area, state, county, city, market, industry, audience gender, audience age, or the like.

In one example, where a client has indicated a preferred audience of middle aged males, the campaign manager module 150 may focus on advertising with sports programs, media entities associated with the outdoors, hunting, fishing, or the like. In another example, where a client has indicated a preferred audience of mothers, the campaign manager module 150 may target media entities more related to children, family, careers, or the like. As previously described, the history module 418 may recognize successful patterns in campaign configuration parameters. Similarly, the history module 418 may identify associations between targeted demographics and successful campaign configuration parameters. For example, a history module 418 may, in one area, determine that politically based media entities may be more successful in reaching audience members that are older. Of course, this disclosure is not limited in this regard. The history module 418 may identify, associate, recognize, or determine that certain sets of configuration parameters may be particularly successful in reaching or influencing certain demographics, and may recommend to a campaign manager module 150 sets of configuration parameters based on a client indicated preference audience.

In one embodiment, a client may, through a user interface module 302 to start or stop an advertising campaign. A client may schedule other start and stop times according to his/her preference. The user interface module 302 may forward such a schedule to the scheduling module 410. The scheduling module 410 may command the resource allocation module 304 to control various media entities according to indicated preferences by the client.

In one embodiment, a new client may indicate a preferred advertisement, preferred audience, preferred reach, preferred impressions, or the like. The campaign manager module 150 may recommend an initial set of configuration parameters based on historical success, recognized patterns, events, or the like, as previously described. A client may accept the recommended configuration parameters, or may alter the configuration parameters. The history module 418 may record the set of configuration parameters and may begin receiving results from the results module 202 in order to begin aggregating results based on the current set of configuration parameters.

In one embodiment, the history module 418 may record received results from the results module into a database. In order to recognize trends in historical data, the history module 418 may mine the data to determine or recognize a pattern as one skilled in data mining may recognize. In another embodiment, the history module 418 may implement artificial intelligence, such as a neural network. For example, a history module 418 may train a neural network based on historical data. The history module 418 may then input client preferences into a trained neural network and output a set of configuration parameters from a neural network.

In another embodiment, a campaign manager module 150 may employ a genetic algorithm. A campaign manager module 150 may make small modifications to an advertising campaign configuration and the results module 202 may measure results. In another embodiment, the configuration module 150 may combine sets of configuration parameters from other campaigns, and execute an advertisement campaign based on the combination of sets of configuration parameters. In this way, over time, a campaign manager module 150 may learn more successful sets of configuration parameters for an advertising campaign. The campaign manager module 150 may then recommend the successful sets of configuration parameters to other clients, or the like.

In one embodiment, the campaign manager module 150 may communicate successful sets of configuration parameters to other advertising agencies. In another embodiment, the campaign manager module 150 may communicate recommended sets of configuration parameters to a client. The campaign manager module 150 may cooperate with other modules or other businesses perform functions of an advertising campaign. The campaign manager module 150 may transmit a configuration of an advertising campaign to the other modules or other businesses. This may allow the campaign manager module 150 and the other advertising agencies, or the client, to cooperate with the campaign manager module 150 in an advertising campaign.

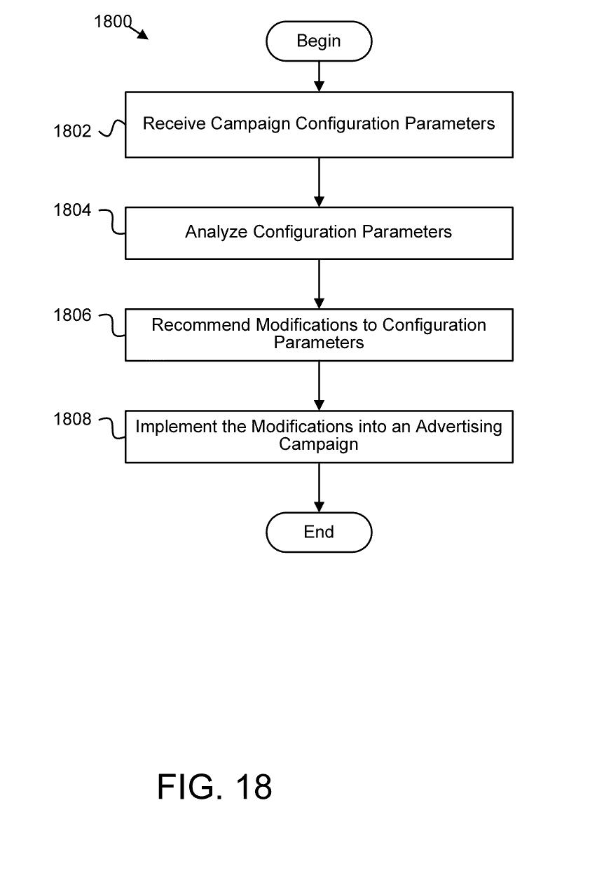

FIG. 18 is a flow chart diagram illustrating another embodiment of a method 1800 in accordance with the present disclosure. The method 1800 begins and a campaign manager module 150 receives a set of campaign configuration parameters. The configuration parameters may be received from a client, a user, another module, or other, or the like. The campaign manager module 150 may analyze 1804 the configuration parameters. The media manager module may recommend 1806 modifications to the configuration parameters. The campaign manager module 150 may partially or fully implement 1808 the recommendations into an advertising campaign.

In another embodiment, a campaign manager module 150 may automatically alter campaign configuration parameters based on contention or cooperation between multiple clients. In one example, a media entity may accept a limited number of advertisements. The campaign manager module 150 may automatically reduce the number of requested advertisements from a set of customers in order to distribute the maximum number of advertisements with the media entity between the clients requesting use of the media entity. The campaign configuration module may reduce a clients' fees or costs in order to compensate for the change in advertising. In another embodiment, the campaign manager module 150 may automatically employ additional media entities to meet a demand by a set of clients, and may distribute use of the additional media entities between the clients requesting use of a similar media entity.

In another embodiment, the campaign manager module 150 may employ several similar media entities and may rate them as high grade, medium grade, low grade, or the like. The campaign manager module 150 may allow clients to specifically select a grade of a media entity, and the campaign manager module 150 may advertise with the specified media entity. In another embodiment, a client may specific use of a media entity types. The campaign manager module 150 may automatically allocate advertisements across various grades of a media entities based on funding provided by the client. In one embodiment, sufficient funds from a client may result in exclusive advertising with a high grade media entity. In another embodiment, lower funds may result in advertising with a lower grade media entity. A client may, or may not, decide which grade of media entity to use, but may specify a media type and an amount of funds available. The campaign manager module 150 may determine which media grade to use based campaign configuration parameters, available funds, media entity availability, or the like.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a campaign manager module that advertises based on an advertising campaign, the advertising campaign comprising a plurality of advertising entities, the advertising campaign based on a set of configuration parameters; and
a results module that monitors results of one or more of the advertising entities,
wherein the campaign manager module updates one or more of the configuration parameters based on the results, and at least a portion of the campaign manager module and the results module comprise one or more of hardware and executable code, the executable code stored on one or more computer readable storage media.

2. The apparatus of claim 1, wherein the campaign manager module generates an initial set of configuration parameters based on one of a set of configuration parameters for a similar advertising campaign and a set of configuration parameters received from a user interface.

3. The apparatus of claim 1, wherein the campaign manager module allocates advertising campaign resources based on available credit.

4. The apparatus of claim 1, wherein the campaign manager module receives updated configuration parameters, the campaign manager module modifies the advertising campaign based on the updated configuration parameters.

5. The apparatus of claim 1, wherein the campaign manager module monitors a reputation and modifies one or more of the configuration parameters based on the reputation.

6. The apparatus of claim 1, wherein the campaign manager module updates one or more remote directories.

7. The apparatus of claim 1, wherein the campaign manager module communicates with one or more advertising entities using an application programming interface.

8. The apparatus of claim 1, wherein the campaign manager module generates a scaled report that compares performance of two or more of the plurality of advertising entities.

9. The apparatus of claim 1, wherein one of more of the modifications is based on a change to one of the plurality of advertising entities.

10. A method comprising:
advertising based on an advertising campaign, the advertising campaign comprising a plurality of advertising entities, the advertising campaign based on a set of configuration parameters;
monitoring results of one or more of the advertising entities; and
modifying one or more of the configuration parameters based on the results.

11. The method of claim 10, further comprising generating an initial set of configuration parameters based on one of a set of configuration parameters for a similar advertising campaign and a set of configuration parameters received from a user interface.

12. The method of claim 10, further comprising allocating advertising campaign resources based on available credit.

13. The method of claim 10, further comprising receiving updated configuration parameters, wherein the modifying is based on the updated configuration parameters.

14. The method of claim 10, wherein the monitoring comprises monitoring a reputation, the modifying further based on the reputation.

15. The method of claim 10, the advertising comprises updating one or more remote directories.

16. The method of claim 10, the advertising comprises communicating with one or more advertising entities using an application programming interface.

17. The method of claim 10, further comprising generating a scaled report that compares performance of two or more of the plurality of advertising entities.

18. The method of claim 10, wherein the modifying is based on changes to an advertising entity.

19. A computer program product comprising a computer readable storage medium having program code embodied therein, the program code readable/executable by a processor for:
advertising based on an advertising campaign, the advertising campaign comprising multiple advertising entities, the advertising campaign based on a set of configuration parameters;
monitoring results of one or more of the advertising entities; and
modifying one or more of the configuration parameters based on the results.

20. The computer program product of claim 19, the program code further configured for generating a scaled report that compares performance of one or more of the multiple advertising entities.
